(19) United States
(12) Patent Application Publication
(10) Pub. No.: US 2025/0238923 A1
(43) Pub. Date: Jul. 24, 2025

(54) APPARATUS AND METHOD FOR MULTIMODAL DATA FUSION FOR ACCURATE DIAGNOSIS

(71) Applicants: Canon Medical Systems Corporation, Tochigi (JP); The Brigham and Women's Hospital Inc., Boston, MA (US)

(72) Inventors: Kei Mori, Ota-city (JP); David R. Walt, Boston, MA (US)

(21) Appl. No.: 19/020,833

(22) Filed: Jan. 14, 2025

Related U.S. Application Data
(60) Provisional application No. 63/624,676, filed on Jan. 24, 2024.

(51) Int. Cl. G06T 7/00

(52) U.S. Cl. CPC G06T 7/0012; G06T 2207/10081; G06T 2207/10088; G06T 2207/10104; G06T 2207/10116; G06T 2207/10121; G06T 2207/10132; G06T 2207/20081; G06T 2207/30068; G06T 2207/30096

(57) ABSTRACT

According to some embodiments, a method comprises obtaining data in multiple modalities, including data in an image modality and data in a biomarker modality; obtaining one or more trained machine-learning models; generating a first multi-modality group from the data in multiple modalities, wherein the first multi-modality group includes data in at least the image modality and in the biomarker modality; generating a group of intermediate data, wherein generating the group of intermediate data includes inputting the first multi-modality group into a machine-learning model that has been trained to extract features from input multi-modality data and output the features as the intermediate data; and generating a first classification result based on at least the group of intermediate data, wherein generating the first classification result includes inputting the intermediate data into a machine-learning model that has been trained to output the classification result based on the group of intermediate data.

### CROSS-REFERENCE TO RELATED APPLICATIONS

This application claims the benefit of U.S. Application No. 63/624,676, which was filed on Jan. 24, 2024 and which is incorporated by reference herein.

### FIELD

This application generally concerns using machine learning to fuse multiple modalities of data for accurate diagnosis.

### BACKGROUND

Medical imaging can produce (e.g., reconstruct) images of an object's internal structures, such as the internal members of a patient's body. For example, computed tomography (CT) scans use multiple X-ray images of an object, which were taken from different angles, to reconstruct volume images of the interior of the object.

Also, liquid biopsies analyze biological analytes that circulate in a patient's blood. For example, some liquid biopsies analyze biomarkers such as proteins, DNA, and RNA.

### BRIEF DESCRIPTION OF THE DRAWINGS

FIG. 1 illustrates an example embodiment of a medical-data-processing system.

FIG. 2 illustrates an example embodiment of an operational flow for generating a classification result from multiple modalities of data.

FIG. 3 illustrates an example embodiment of an operational flow for generating a classification result from multiple modalities of data.

FIG. 4 illustrates an example embodiment of an operational flow for generating a classification result from multiple modalities of data.

FIG. 5A illustrates examples of multi-modality groups that are formed by grouping data from multiple modalities and an example of a single-modality group that has not been grouped into a multi-modality group.

FIG. 5B illustrates the multi-modality groups from FIG. 5A after the data with low intra-group, inter-modality correlations have been removed.

FIG. 5C illustrates the intermediate-data groups and single-modality groups after part of intermediate fusion has been performed on the multi-modality groups in FIG. 5B.

FIG. 5D illustrates the intermediate-data groups and single-modality groups from FIG. 5C after the intermediate-data groups and the single-modality groups that have high inter-group correlations have been re-grouped into a high-correlation group.

FIG. 5E illustrates first classification results that were generated based on the high-correlation group and the intermediate-data group in FIG. 5D, as well as a single-modality group.

FIG. 5F illustrates initial classification results that were generated based on the high-correlation group and the intermediate-data group in FIG. 5D and a first classification result that was generated based on the single-modality group in FIG. 5E that was marked with a late-fusion flag.

FIG. 6 illustrates an example embodiment of the grouping and fusion of multiple modalities of data.

FIG. 7 illustrates an example embodiment of the grouping and fusion of multiple modalities of data.

FIG. 8 illustrates the flow of information in a multi-modal data-processing procedure that can be performed by a data-processing device.

FIG. 9 illustrates an example embodiment of a neural network.

FIG. 10 illustrates an example embodiment of a convolutional neural network (CNN).

FIG. 11 illustrates an example of implementing a convolution layer for one neuronal node of the convolution layer, according to an example embodiment.

FIG. 12 illustrates the flow of information in a method for generating a classification result from multiple modalities of data.

FIG. 13 illustrates an example embodiment of an operational flow for generating a classification result from multiple modalities of data.

FIG. 14 illustrates an example embodiment of an operational flow for generating a classification result from multiple modalities of data.

FIG. 15 illustrates an example embodiment of operations that can be substituted for blocks B1420-B1430 in FIG. 14.

FIG. 16 illustrates an example embodiment of a data-processing device.

FIG. 17 illustrates the functional configuration of an example embodiment of a data-processing device.

### DETAILED DESCRIPTION

The following paragraphs describe certain explanatory embodiments. Other embodiments may include alternatives, equivalents, and modifications. Additionally, the explanatory embodiments may include several novel features, and a particular feature may not be essential to some embodiments of the devices, systems, and methods that are described herein. Furthermore, some embodiments include features from two or more of the following explanatory embodiments. Thus, features from various embodiments may be combined and substituted as appropriate.

Also, as used herein, the conjunction “or” generally refers to an inclusive “or,” although “or” may refer to an exclusive “or” if expressly indicated or if the context indicates that the “or” must be an exclusive “or.”

Moreover, as used herein, the terms “first,” “second,” and so on, do not necessarily denote any ordinal, sequential, or priority relation and may be used to more clearly distinguish one member, operation, element, group, collection, set, region, section, etc. from another without expressing any ordinal, sequential, or priority relation. Thus, a first member, operation, element, group, collection, set, region, section, etc. discussed below could be termed a second member, operation, element, group, collection, set, region, section, etc. without departing from the teachings herein.

And in the following description and in the drawings, like reference numbers designate identical or corresponding members throughout the several views.

Additionally, some embodiments are set forth in the following paragraphs:
(1) A method for generating classification results comprising obtaining data in multiple modalities, including data in an image modality and data in a biomarker modality; obtaining one or more trained machine-learning models; generating a first multi-modality group from the data in multiple modalities, wherein the first multi-modality group includes at least one of data in the image modality and data in the biomarker modality; generating a group of intermediate data, wherein generating the group of intermediate data includes inputting the first multi-modality group into a first machine-learning model that has been trained to extract features from input multi-modality data and output the features as the intermediate data; and generating a first classification result based on at least the group of intermediate data, wherein generating the first classification result includes inputting at least the group of intermediate data into a second machine-learning model that has been trained to output the classification result based on at least the group of intermediate data.
(2) The method of (1), wherein the data in the image modality include data that define one or more of the following: an x-ray image, a computed-tomography image, a magnetic-resonance-imaging image, a fluoroscopic image, an ultrasound image, and a positron-emission-tomography image.
(3) The method of (1), wherein generating the first multi-modality group includes grouping the data in multiple modalities into the first multi-modality group and one or more other groups, based on the data in multiple modalities and on one or more grouping criteria.
(4) The method of (3), wherein the grouping criteria are related to at least one of data formats and correlations between data.
(5) The method of (1), wherein the data in multiple modalities further include data in a text modality.
(6) The method of (1), wherein generating the first classification result further includes inputting a group of single-modality data into the second machine-learning model with the group of intermediate data, and wherein the second machine-learning model has been trained to output the classification result further based on the group of single-modality data.
(7) The method of (1), further comprising generating a second classification result based on a group of single-modality data from the data in multiple modalities, wherein generating the second classification result includes inputting the group of single-modality data into a third machine-learning model that has been trained to output the classification result based on the group of single-modality data.
(8) The method of (7), further comprising generating a third classification result based on the first classification result and the second classification result.
(9) The method of (8), wherein the third classification result indicates one or more of the following: whether a tumor is benign or malignant; whether a tumor is an invasive cancer or a non-invasive caner; and whether a cancer is a Luminal type, Her2-enriched type, or Triple Negative Breast Cancer subtype.
(10) A device comprising one or more processors and one or more memories. The one or more processors and the one or more memories are configured to obtain data in multiple modalities, including data in an image modality and data in a biomarker modality; obtain one or more trained machine-learning models; generate a first multi-modality group from the data in multiple modalities, wherein the first multi-modality group includes at least one of data in the image modality and data in the biomarker modality; generate a group of intermediate data, wherein generating the group of intermediate data includes inputting the first multi-modality group into a first machine-learning model that has been trained to extract features from input multi-modality data and output the features as the intermediate data; and generate a first classification result based on at least the group of intermediate data, wherein generating the first classification result includes inputting at least the group of intermediate data into a second machine-learning model that has been trained to output the classification result based on at least the group of intermediate data.
(11) One or more computer-readable media storing instructions that, when executed by one or more computing devices, cause the one or more computing devices to perform operations comprising obtaining data in multiple modalities, including data in an image modality and data in a biomarker modality; obtaining one or more trained machine-learning models; generating a first multi-modality group from the data in multiple modalities, wherein the first multi-modality group includes at least one of data in the image modality and data in the biomarker modality; generating a group of intermediate data, wherein generating the group of intermediate data includes inputting the first multi-modality group into a first machine-learning model that has been trained to extract features from input multi-modality data and output the features as the intermediate data; and generating a first classification result based on at least the group of intermediate data, wherein generating the first classification result includes inputting at least the group of intermediate data into a second machine-learning model that has been trained to output the classification result based on at least the group of intermediate data.
(12) A method comprising obtaining data in a first modality and data in a second modality; obtaining one or more trained machine-learning models; generating groups of multi-modality data from the data in the first modality and the data in the second modality, wherein each of the groups of multi-modality data includes some of the data in the first modality and some of the data in the second modality; inputting each of the groups of multi-modality data into one of a first plurality of machine-learning models, wherein each machine-learning model of the first plurality of machine-learning models outputs a respective group of intermediate data that the machine-learning model generated based on the input group of multi-modality data; inputting the groups of intermediate data into a second plurality of machine-learning models, wherein each machine-learning model of the second plurality of machine-learning models outputs a respective classification result that the machine-learning model generated based on the input group of intermediate data.
(13) A method comprising obtaining data in multiple modalities; obtaining one or more grouping criteria; obtaining one or more trained machine-learning models; generating groups of multi-modality data from the data in multiple modalities according to the one or more grouping criteria, wherein each of the groups of multi-modality data includes data in at least two modalities; and performing intermediate fusion on one or more groups of multi-modality data using one or more of the trained machine-learning models, which generates one or more first classification results.
(14) The method of (13), further comprising performing early fusion on at least one group of single-modality data from the data in multiple modalities one or more of the trained machine-learning models, which generates one or more first classification results.
(15) The method of (14), further comprising performing late fusion on the first classification results using one or more late-fusion models, which generates a second classification result.
(16) The method of (15), wherein late fusion is performed using a majority-voting model, a weighted-average model, or a stacking model.
(17) A device comprising one or more processors and one or more memories. The one or more processors and the one or more memories are configured to obtain data in multiple modalities; obtain one or more grouping criteria; obtain one or more trained machine-learning models; generate groups of multi-modality data from the data in multiple modalities according to the one or more grouping criteria, wherein each of the groups of multi-modality data includes data in at least two modalities; and perform intermediate fusion on one or more groups of multi-modality data using one or more of the trained machine-learning models, which generates one or more first classification results.
(18) One or more computer-readable media storing instructions that, when executed by one or more computing devices, cause the one or more computing devices to perform operations comprising obtaining data in multiple modalities; obtaining one or more grouping criteria; obtaining one or more trained machine-learning models; generating groups of multi-modality data from the data in multiple modalities according to the one or more grouping criteria, wherein each of the groups of multi-modality data includes data in at least two modalities; and performing intermediate fusion on one or more groups of multi-modality data using one or more of the trained machine-learning models, which generates one or more first classification results.

Various embodiments will be described hereinafter with reference to the accompanying drawings.

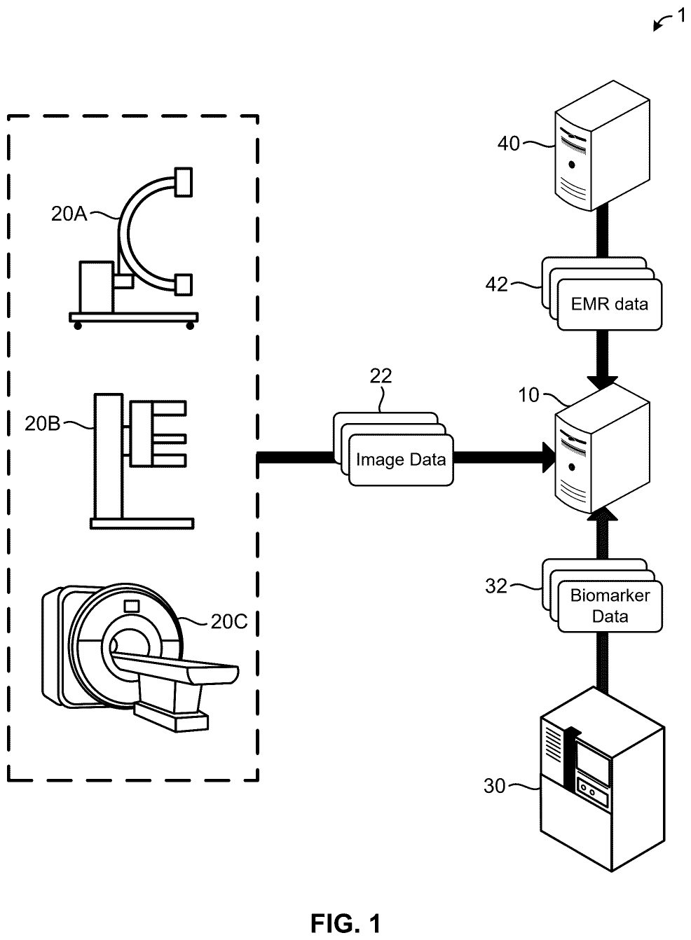

FIG. 1 illustrates an example embodiment of a medical-data-processing system 1. The medical-data-processing system 1 includes at least one data-processing device 10, one or more imaging devices 20A-C, a biomarker-analysis device 30, and a server 40.

In this embodiment, the imaging devices 20A-C include a C-arm computed tomography (CT) scanner 20A, a mammography device 20B, and a magnetic-resonance-imaging (MRI) scanner 20C. These are examples of imaging devices, and other embodiments may include more imaging devices, fewer imaging devices, different imaging devices (e.g., ultrasound devices, photoacoustic-imaging devices), a single imaging device (e.g., only a mammography device 20B), and different combinations of imaging devices (e.g., both a mammography device 20B and an ultrasound device).

When the imaging devices 20A-C perform an imaging operation on a subject (e.g., a patient), the imaging devices 20A-C generate and output groups of image data 22 that define one or more images of the subject. The images may be two-dimensional (2D) or three-dimensional (3D) images.

The biomarker-analysis device 30 performs liquid biopsies on samples (e.g., blood) from patients. Liquid biopsies analyze biological analytes (biomarkers) that circulate in a patient's liquid samples, such as blood or urine. For example, some liquid biopsies analyze biomarkers, such as proteins, DNA, and RNA.

In some embodiments, the biomarker-analysis device 30 is an automated assay device that includes at least one controller, an assay-consumable handler, a sample loader, a sealer, and an imaging system. The assay-consumable handler can be operatively coupled to an assay consumable, and the assay consumable includes a plurality of assay sites. The sample loader is configured to load an assay sample (e.g., comprising a plurality of analyte molecules or particles) into the assay sites of the assay consumable. The sealer is configured to apply a sealing component to the surface of the assay consumable. The imaging system is configured to acquire one or more images of the assay sites of the assay consumable. The biomarker-analysis device 30 may also include a bead loader that is separate from or associated with the sample loader, a rinser that is configured to rinse the surface of the assay consumable, a reagent loader that is configured to load a reagent into the assay sites of the assay consumable, and a wiper that is configured to remove excess beads from the surface of an assay substrate. And the one or more controllers may control the other components (the assay-consumable handler, the sample loader, the sealer, the imaging system, the bead loader, the rinser, the wiper) of the biomarker-analysis device 30.

Based on the images that are acquired by the imaging system of the biomarker-analysis device 30, the biomarker-analysis device 30 completes a biomarker analysis on sample from a subject (e.g., a patient), and the biomarker-analysis device 30 generates and outputs biomarker data 32 (e.g., groups of biomarker data 32), which indicate the results of the biomarker analysis (e.g., a group of biomarker data 32 may indicate the results of a respective liquid biopsy). For example, the biomarker-analysis device 30 can perform a liquid biopsy, which less invasively determines whether a subject has cancer by analyzing biological analytes (biomarkers, such as proteins, DNA, and RNA) circulating in the peripheral blood near a lesion. When performing a liquid biopsy, the biomarker-analysis device 30 measures the concentration (amount) of the biological analyte, detects the presence of any mutations (in the case of nucleic acid (NA) analysis), or measures the copy number variation (CNV).

Examples of protein biomarkers include the following: CA15-3, CA19-9, and CA125. And examples of tumor associated autoantibodies (TAAbs) biomarkers include the following: HSP-47 (SERPINH1), HSP-60, HSP70, HSP-90, CA15-3, SELL, ANGPTL3, HSP-90, HGF, HER2, Progranulin, c-myc, HOXD10, SOX2, Endostatin, GIPC-1, GRAF-1A, GPR157, DKK1, ZNF514, and BDNF. Other examples of biomarkers that can be used are described in WO2022/140576. For purposes of describing the biomarkers, the summary, drawings, and detailed description of WO2022/140576 are incorporated by reference herein, except for any definitions, subject matter disclaimers or disavowals, and except to the extent that the incorporated material is inconsistent with the express disclosure herein, in which case the language in this disclosure controls.

The server stores electronic-medical-record (EMR) data 42, which define one or more electronic medical records. Electronic medical records may include at least some of the following: clinical findings, for example examination name, examination result, diagnosis name, radiogram interpretation report information; medication information; medical treatment information; the dates and time of clinical findings, medications, and treatments; patient symptoms; and patient information (e.g., weight, height, age).

For example (e.g., when diagnosing breast cancer), the EMR data 42 may indicate at least some of the following: whether a patient has ever had a breast biopsy, the number of biopsies that have been performed on a patient, the number of times that a patient has been pregnant, a patient's age when the patient's first child was born, a patient's age when the patient's last child was born, whether the patient has breastfed a child for at least a month, whether a patient has smoked at least 100 cigarettes in the patient's lifetime, whether a patient has ever consumed alcohol, a patient's average alcohol consumption per week, whether a patient has ever had diabetes or high blood sugar when not pregnant, whether a patient has ever used hormone-based contraceptives, and whether a patient has even undergone hormonal therapy.

The server may also store image data 22 and biomarker data 32.

The data-processing device 10 obtains data in an image modality (the groups of image data 22); data in a biomarker modality (the biomarker data 32); and, in some embodiments, data in another modality, such as a text modality (for example, the EMR data 42). The data-processing device 10 then uses at least two modalities of the groups of image data 22, the biomarker data 32, and the EMR data 42 to produce one or more classification results. Examples of classification results include diagnoses and medical predictions, and thus the classification results may indicate the presence or absence of a medical condition. A classification result may also indicate the respective presences or absences of multiple diagnoses, and a classification result may indicate a respective likelihood of each diagnosis that is included in the classification result. For example, a classification result may indicate at least some of the following: the presence of absence of a cancer, such as breast cancer; whether a tumor is benign or malignant; a type of cancer, for example invasive or non-invasive; and a cancer molecular subtype (e.g., Luminal type, Her2-enriched type, or Triple Negative Breast Cancer subtype).

Thus, the data-processing device 10 uses (e.g., fuses) at least two modalities of data (image data 22, biomarker data 32, and EMR data 42) to generate one or more classification results, such as a diagnosis. By using at least two modalities of data to generate the classification results, the data-processing device 10 may generate more accurate classification results.

For example, the diagnosis of breast cancer is typically performed using medical imaging, specifically mammograms. Mammograms are capable of detecting morphological image lesions in the breast that may be related to breast cancer, such as the following: mass and calcification, and architectural distortion. However, distinguishing benign from malignant lesions is very difficult using only mammograms.

Consequently, the pathological diagnosis of breast cancer tissue is typically performed by conducting a needle biopsy to determine a benign finding or, alternatively, a malignant finding. Thus, when a tumor-like lesion is found in a mammogram, a needle biopsy will be performed even if the tumor-like lesion appears to be benign, which results in a benign result, which in turn indicates that the biopsy was unnecessary. And as indicated by biopsy results, mammogram-only diagnoses tend to have a very high false-positive rate (approximately 80% of biopsies may show benign results).

The data-processing device 10 integrates and interpolates diagnostic information obtained from two or more modalities to improve classification accuracy (e.g., diagnostic accuracy, prediction accuracy) compared to a classification that uses only a mammogram. This can reduce unnecessary biopsies. In addition, because different data are available at different facilities, the data-processing device 10 is able to adjust to the available data at a facility.

To generate classification results, the data-processing device 10 is configured to use early data fusion (early fusion), intermediate data fusion (intermediate fusion), and late data fusion (late fusion), and is also configured to determine when to use early fusion, intermediate fusion, and late fusion.

Early fusion incorporates data from one or more modalities into one information space or one machine-learning (ML) model, which generates a classification result based on the modalities of input data. Thus, ML models that are used in early fusion (early-fusion models) accept one or more modalities of input data and output classification results based on the input data.

Intermediate fusion uses a set of ML models. One or more of the ML models in the set are used to extract data features from two or more modalities, and one or more of the other models in the set then integrate (or combine) the extracted features to generate a classification result. Thus, in intermediate fusion, at least one ML model accepts one or more modalities of data as inputs and outputs features that are based on the input data, and at least one ML model accepts features as inputs and outputs one or more classification results that are based on the input features.

Late fusion uses one or more late-fusion models to aggregate multiple classification results into a single classification result. Thus, a late-fusion model accepts classification results as inputs and outputs one or more classification results based on the input classification results. To distinguish between the classification results that are output by a late-fusion model from the classification results that are output by an early-fusion model or an ML model in intermediate fusion, a classification result that is output by a late-fusion model may be referred to herein as a “second classification result,” and a classification result that is output by an early-fusion model and an ML model in intermediate fusion may be referred to herein as a “first classification result.”

Also, an output set may define all of the possible classification results that can be output by the ML models (in one or both of early fusion and late fusion) and the late-fusion models. For example, some output sets include only the following classification results: healthy, benign, and malignant. Thus, in such embodiments, when an ML model or late-fusion model outputs a classification result, the output classification result is one (and, in some embodiments, only one) of the following: healthy, benign, and malignant. Also for example, other output sets include different cancers, such as breast cancer, lung cancer, gastric cancer, liver cancer, pancreatic cancer, and colon cancer. And the classification result may also include the probability of occurrence, for example breast cancer=75%, lung cancer=20%, etc.

For example, if the classification objective is diagnosing the presence or absence of breast cancer, then the output set may be constituted by the following: healthy, benign, and malignant. Or the output set may be constituted by breast cancer, lung cancer, other cancer, and no cancer. Also, as noted above, the classification result may include each member of the output set along with a respective probability of occurrence.

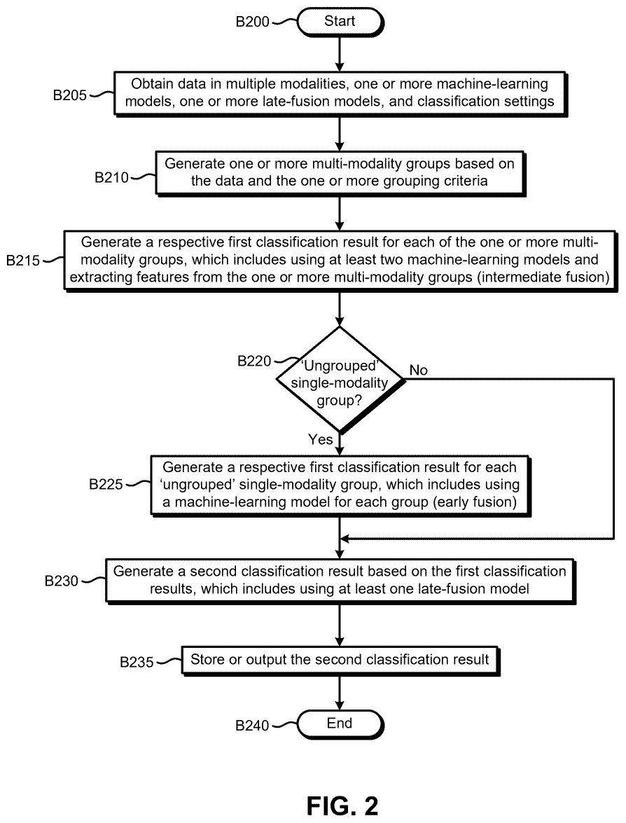

FIG. 2 illustrates an example embodiment of an operational flow for generating a classification result from multiple modalities of data. Although this operational flow and the other operational flows that are described herein are each presented in a certain order, some embodiments may perform at least some of the operations in different orders than the presented orders. Examples of different orders include concurrent, parallel, overlapping, reordered, simultaneous, incremental, and interleaved orders. Thus, other embodiments of the operational flows that are described herein may omit blocks, add blocks, change the order of the blocks, combine blocks, or divide blocks into more blocks.

Furthermore, although the operational flows in the embodiments that are described herein are performed by a data-processing device 10, in some embodiments, the operational flows are performed by two or more data-processing devices 10 or by one or more other specially-configured computing devices.

The flow begins in block B200 and moves to block B205, where a data-processing device 10 obtains data, one or more machine-learning models (ML models), one or more late-fusion models, and classification settings. The data are in multiple modalities. Different modalities have different data formats, and different modalities capture and represent different features. For example, modalities include image modalities, biomarker modalities, and an electronic-medical-record (EMR) modality.

Examples of image modalities include an x-ray modality (e.g., two-dimensional (2D) x-ray images, computed-tomography (CT) images), a magnetic-resonance-imaging (MRI) modality, a fluoroscopic modality, an ultrasound modality, a tomosynthesis modality, a positron-emission-tomography (PET) modality, an endoscope modality, and a digital-pathology-scanner modality.

Data in a biomarker modality (biomarker data) indicate the presence of biomarkers. For example, biomarker data may indicate a quantity (e.g., a count or concentration, such as mass concentration, molar concentration, number concentration, and volume concentration) of respective biomarkers. Examples of biomarkers include protein biomarkers, protein biomarkers that perform one or more particular biological roles, tumor-associated autoantibody (TAA) biomarkers, deoxyribonucleic acid (DNA) biomarkers, ribonucleic acid (RNA) biomarkers, metabolite or lipid biomarkers, circulating tumor cell biomarkers, exosome biomarkers, cytometric biomarkers, and glycan biomarkers. Thus, the biomarker data include an identifier (e.g., name, code) of one or more biomarkers along with respective numerical data that indicate a respective quantity of each of the one or more the biomarkers. And examples of biomarker modalities include the following: a protein modality, a DNA modality, an RNA modality, a metabolite modality, a lipid modality, an exosome modality, a cytometric modality, a glycan modality, and an ion modality.

Also, the data may be obtained in the form of multiple groups of single-modality data (multiple single-modality (SM) groups). Each SM group includes data in only one modality. For example, a group of single-modality data (a SM group) may define one image or one part of an image (e.g., a region of interest (ROI)), and a group of single-modality data (a SM group) may include identifiers and numerical data for a set of biomarkers.

The classification settings include one or more grouping criteria (which may be defined by one or more grouping policies). And the classification settings may include, for example, one or more classification objectives, such as determining a presence or absence of a disease (e.g., breast cancer) or condition, or one or more output sets. The classification settings may also include selections of the ML models and the late-fusion models that are to be used.

Next, in block B210, the data-processing device 10 generates one or more groups of multi-modality data (multi-modality (MM) groups) based on the data and on the one or more grouping criteria. Each MM group includes data in two or more modalities. For example, the data-processing device may generate an MM group by grouping together two SM groups of different modalities.

For example, the one or more grouping criteria (which may be included in one or more grouping policies) may define multiomics groups, each of which is associated with one or more “omes,” based on functional and biological aspects. Examples of “omes” include the following: genome, proteome, transcriptome, epigenome, metabolome, and microbiome. Thus, examples of multiomic groups include genomics groups, epigenomics groups, transcriptomics groups, proteomics groups, and metabolomics groups. Other examples of multiomic groups include radiomics groups and phenotypic groups.

Furthermore, the data can be grouped according to the format of the data. Examples of formats include numerical formats and textual formats. Additionally, numerical data (data in a numerical format) can be continuous (have a continuous format) or discrete (have a discrete format).

Also, data can be grouped into more than one multi-modality group. For example, a F-fluorodeoxyglucose (FDG) PET image (FDG-PET image) can be grouped into both a radiomics MM group and a metabolomics MM group.

Thus, examples of MM groups include the following: groups that include different radiomics data, groups that include biomarker data from multiple multiomic groups, groups that include both radiomics data and biomarker data that belong to a specific multiomics group (or a specific subset (a proper subset) of the multiomics groups), and groups that include both textual information (e.g., EMR data) and numerical data (e.g., radiomics data, biomarker data).

The flow then proceeds to block B215, where the data-processing device 10 generates a respective initial classification result for each of the one or more MM groups. When generating the initial classification results, the data-processing device 10 uses at least two machine-learning (ML) models. The data-processing device 10 inputs each MM group into an ML model that outputs features based on the inputs, and then the data-processing device 10 inputs the features into an ML model that outputs at least one initial classification result based on the inputs. For example, in block B215, the data-processing device may use an artificial neural network to extract features from each of the MM groups, and then input the features into a shallow classification model or deep neural network that has been trained to output an initial classification result based on input features. Thus, in block B215, the data-processing device performs intermediate fusion on the MM groups.

Also, after obtaining the features, the data-processing device 10 may generate new groups from the features and from other data (e.g., from one or more single-modality (SM) groups) and then input the new groups into the ML model that outputs the at least one initial classification result.

And, of the data in the modality or modalities that are accepted by each ML model, some ML models accept a subset of the data. For example, one ML model may accept a subset of the image data as inputs, and another ML model may accept a subset of the biomarker data as inputs. Also for example, some ML models that accept image data as inputs accept one or more of the following as inputs: a whole 2D or 3D image (e.g., a whole mammogram, a screening mammogram, a diagnostic mammogram), and a region of interest (ROI) in a 2D or 3D image (e.g., an ROI in a screening mammogram, an ROI in a diagnostic mammogram). Furthermore, for example, some ML models accept other electronic data, such as EMR data, as inputs.

Also, as noted above, the ML models may be artificial neural networks. Examples of artificial neural networks include deep neural networks, feed-forward neural networks (e.g., convolutional neural networks), recurrent neural networks, and deep-belief neural networks.

Each of the neural networks may operate on different data (e.g., accept different data as inputs), and each neural network outputs features that are extracted from the inputs to the neural network. For example, in some embodiments, one neural network accepts all biomarkers in the enzyme group as inputs, one neural network accepts the biomarkers in the gProtein group (which is a proper subset of the protein group) as inputs, one neural network accepts DNA biomarkers as inputs, one neural network accepts whole mammograms as inputs, and one neural network accepts region-of-interest images (images of regions of interest that have been cropped from whole images) from mammograms as inputs. Also, in some embodiments, each of the neural networks accepts inputs that are the same as the inputs that are accepted by one or more of the classification models that are shown below in Table 1.

The features that are output by the neural networks may be the features that are the most relevant (either through their presence or their absence) to the generation of the first classification results or the second classification results.

Additional examples of ML models include classification models (e.g., shallow classification models). Examples of classification models include the following: logistic-regression models, K-nearest-neighbors (KNN) classification models, Naïve Bayes classification models, decision-tree classification models, support-vector-machine (SVM) classification models (e.g., with a linear kernel, with a radial kernel), Gaussian-process classification models, multi-layer-perceptron (MLP) classification models, ridge-regression classification models, random-forest classification models, quadratic-discriminant-analysis classification models, AdaBoost classification models, gradient-boosting classification models, linear-discriminant-analysis (LDA) classification models, extra-trees classification models, and boosting classification models (e.g., extreme-gradient-boosting classification models and light-gradient-boosting classification models).

Next, in block B220, the data-processing device 10 determines whether there is any ‘ungrouped’ SM group, which is an SM group that was not grouped into an MM group in block B210 and was not grouped with features in block B215. If there is no ‘ungrouped’ SM group (B220=No), then the flow advances to block B230. If there is at least one ‘ungrouped’ SM group (B220=Yes), then the flow advances to block B225.

In block B225, the data-processing device 10 generates a respective classification result for each ‘ungrouped’ SM group. When generating a classification result in block B225, the data-processing device 10 uses an ML model that is an early-fusion model. As noted above, an early-fusion model accepts one or more modalities of data (including one or more SM groups) as inputs and outputs one or more classification results based on the input data. Each of the ML models that is used with the ‘ungrouped’ SM groups may accept inputs in only one data format.

The data-processing device 10 may input each ‘ungrouped’ SM group into only one early-fusion model and may input only one ‘ungrouped’ SM group at a time, and thus may generate one classification result for each ‘ungrouped’ SM group. And, the data-processing device 10 may input different ‘ungrouped’ SM groups into different early-fusion models. Also, the data-processing device 10 may input two or more ‘ungrouped’ SM groups into some early-fusion models, such as early-fusion models that accept multiple modalities of data. If one or more of the two or more ‘ungrouped’ SM groups are not in the format that is accepted by the early-fusion model, then the data-processing device 10 may convert such ‘ungrouped’ SM groups to the format that is accepted by the early-fusion model. Thus, the data in the two or more ‘ungrouped’ SM groups that are input into an early-fusion model have the same format even if the data are in different modalities.

Furthermore, early-fusion models may be classification models, which operate as classifiers and which output first classification results.

Each classification model outputs a respective classification result, and each classification model may operate on different data (e.g., accept different SM groups as inputs). For example, Table 1 shows the respective data that twenty-three classification models operate on (accept as inputs). Also, the biomarker modalities of the input data in Table 1 includes the following modalities: a growth-factor modality, an enzyme modality, a cell-proliferation modality, a gProtein modality, a phosphorylation modality, an inflammation modality, a tumor-associated-autoantibodies (TAAbs) modality, a DNA modality, an RNA modality, a Metabolite/Lipid modality, a circulating-tumor-cell modality, and a exosome/EV modality. The image modality of the input data in Table 1 is a mammogram modality.

TABLE 1
(BM = Biomarker, MG = mammogram, ROI = region of interest)

| Data Type | Input Data | Classification Model |
|---|---|---|
| non-image | Protein BMs_Whole | cl₁ |
| non-image | Protein BMs_Group1 (G1): Growth Factor | cl₂ |
| non-image | Protein BMs_Group2 (G2): Enzyme | cl₃ |
| non-image | Protein BMs_Group3 (G3): Cell proliferation | cl₄ |
| non-image | Protein BMs_Group4 (G4): gProtein | cl₅ |
| non-image | Protein BMs_Group5 (G5): Phosphorylation | cl₆ |
| non-image | Protein BMs_Group6 (G6): Inflammation | cl₇ |
| non-image | Protein BMs_G1 + G2 | cl₈ |
| non-image | Protein BMs_G1 + G2 + G3 | cl₉ |
| non-image | Protein BMs_G1 + G2 + G3 + G4 | cl₁₀ |
| non-image | Tumor Associated Autoantibodies (TAAbs) | cl₁₁ |
| | BMs | |
| non-image | Electronic Medical Record (EMR) | cl₁₂ |
| non-image | DNA BMS | cl₁₃ |
| non-image | RNA BMS | cl₁₄ |
| non-image | Metabolite/Lipid BMs | cl₁₅ |
| non-image | Circulating Tumor Cell BMs | cl₁₆ |
| non-image | Exosome/EV BMs | cl₁₇ |
| image | MG whole Images | cl₁₈ |
| image | MG whole ROI Images | cl₁₉ |
| image | MG 2D ROI Images | cl₂₀ |
| image | MG 3D ROI Images | cl₂₁ |
| image | Screening MG ROI Images | cl₂₂ |
| image | Diagnostic MG ROI Images | cl₂₃ |

In Table 1, classification model cl₁ accepts all biomarkers in the protein group as inputs (and thus accepts data in all protein biomarker modalities); classification model cl₃ accepts the biomarkers in the enzyme group (which is a proper subset of the protein group) as inputs (and thus accepts data in the enzyme modality); classification model cl₉ accepts the biomarkers in protein groups 1, 2, and 3 (which are the growth factor, enzyme, and cell proliferation groups) as inputs (and thus accepts data in the growth factor, enzyme, and cell proliferation modalities); classification model cl₁₂ accepts EMR data as inputs (and thus accepts data in the EMR modality); classification model cl₁₈ accepts whole mammograms as inputs; and classification model cl₂₁ accepts region-of-interest images (images of regions of interest that have been cropped from whole images) from 3D mammograms as inputs (and thus accepts data in the mammogram modality).

Thus, for example, if the data-processing device 10 used the twenty-three classifiers in Table 1 to perform initial classifications on twenty-three applicable ‘ungrouped’ SM groups in block B225, then the date-processing device 10 would generate twenty-three first classification results in block B225.

The flow then moves to block B230, where the data-processing device 10 generates a second classification result based on some of or all of the first classification results that were generated in block B215, and, if block B225 was performed, in block B225. To generate the second classification result, the data-processing device 10 inputs the first classification results into at least one late-fusion model, which outputs the second classification result based on the inputs. The second classification result may include one member of an output set or it may include multiple members of an output set with a respective probability for each member.

Some late-fusion models are ML models, and some late-fusion models are not ML models. And examples of late-fusion models include the following: majority-voting models, weighted-average models, and stacking models.

Some majority-voting models (hard-voting majority-voting models) count the number of input classification results and obtain the classification result that has the highest number of votes as the second classification result. For example, some embodiments of majority-voting models generate a second classification result H(x) that can be described by the following:

$$H ( x ) = {arg max}_{j} {{\sum }_{i}}^{C} {cr}_{i}^{j} , \qquad ( 1 )$$

where crᵢ is the i-th classification result, where C is the total number of classification results, and where j is the j-th classification result in the output set, which is the set of possible classification results (e.g., a set that is composed of three results: ‘healthy’ (j=1), ‘benign’ (j=2), and ‘malignant’ (j=3)). All classification results have the same weight. And, in some embodiments, for majority voting to be successful, the number of input classification results must be an odd number, and the odd number must be greater than or equal to three.

Also for example, in some embodiments, the second classification result H(x) that is generated by a majority-voting model can be described by the following:

$$H ( x ) = {arg max}_{j} {\sum }_{i}^{L} {cl}_{i}^{j} ( {x}_{i} ) , \qquad ( 2 )$$

where clᵢ is the i-th ML model that outputs a classification result (e.g., classifier), where L is the total number of ML models, where xᵢ is the data that is input to the i-th ML model, and where clᵢ^{j}(xᵢ) is the classification result (the output) of the i-th ML model on the j-th classification result in the output set.

Some majority-voting models (soft-voting majority-voting models) calculate the probability of each classification result. For example, some embodiments of majority-voting models generate classification results H(x) that can be described by the following:

$$H ( x ) = {\sum }_{i}^{C} {cl\_prob}_{i} , \qquad ( 3 )$$

where cl_probᵢ is the probability of the i-th classification result, and where C is the total number of classification results. Also, these majority-voting models may select the classification result that has the highest probability as the second classification result.

A weighted-average model assigns different weights to each classification result and integrates the classification results by a linear weighted sum. For example, in some embodiments, the second classification result H(x) that is generated by a weighted-average model can be described by the following:

$$H ( x ) = {\sum }_{i}^{C} {w}_{i} {cr}_{i} , \qquad ( 4 )$$

where crᵢ is the i-th classification result, where wᵢ is the weight of the i-th classification result, and where C is the total number of classification results.

For example, in some embodiments, the stacking model is a logistic-regression model, and in some such embodiments the second classification result H(x) that is generated by a stacking model can be described by the following:

$$H ( x ) = \frac{1}{1 + {e}^{- ( {β}_{1} {cl}_{1} ( {x}_{1} ) + {β}_{2} {cl}_{2} ( {x}_{2} ) + … + {β}_{L} {cl}_{L} ( {x}_{L} ) + b )}} , \qquad ( 5 )$$

where clᵢ is the i-th ML model that outputs a classification result (e.g., classifier), where xᵢ is the data that is input to the i-th ML model, where L is the total number of ML models, where clᵢ(x) is the classification result of the i-th ML model, and where βᵢ is the rate parameter of the i-th ML model.

Next, in block B235, the data-processing device 10 stores or outputs the second classification result. The first classification results may also be stored or output in block B235. And then the flow ends in block B240.

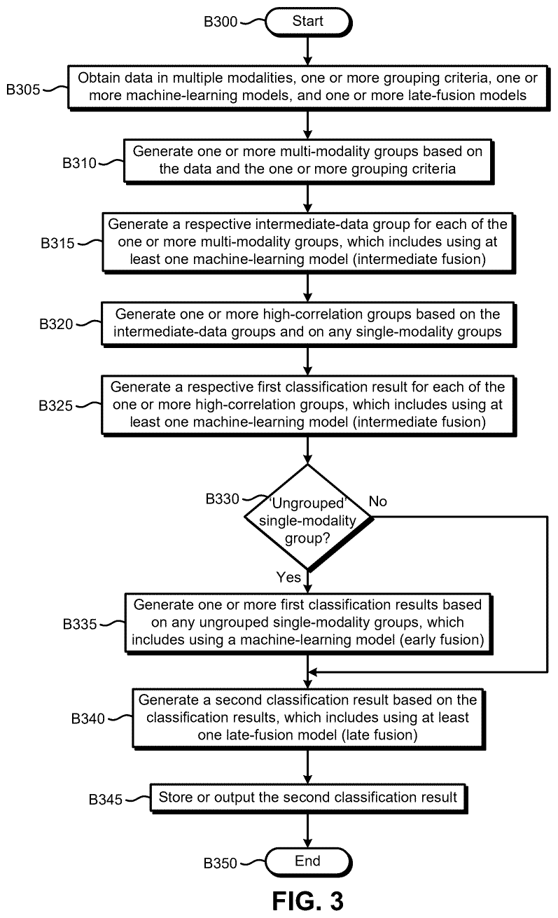

FIG. 3 illustrates an example embodiment of an operational flow for generating a classification result from multiple modalities of data. The flow begins in block B300 and moves to block B305, where a data-processing device 10 obtains data in multiple modalities, one or more grouping criteria (as well as other classification settings), one or more machine-learning models (ML models), and one or more late-fusion models. The data in multiple modalities are composed of a plurality of single-modality (SM) groups.

Next, in block B310, the data-processing device 10 generates one or more groups of multi-modality data (MM groups) based on the data and on the one or more grouping criteria (e.g., on at least one grouping policy).

The flow then moves to block B315, where the data-processing device 10 generates a respective intermediate-data group for each of the one or more MM groups. Block B315 includes inputting each of the MM groups into an ML model that has been trained to extract and output features based on the inputs. The output features constitute the intermediate data in the intermediate-data group. All of the MM groups may be input into the same ML model, or subsets of the MM groups may be input into different ML models. Also, block B315 is a part of intermediate fusion.

Then, in block B320, the data-processing device 10 generates one or more high-correlation groups based on the intermediate-data groups and on any SM groups that were not grouped into an MM group in block B310. The high-correlation groups are generated by grouping each intermediate-data group with the other intermediate groups that have high correlations (correlations that exceed a threshold or that satisfy one or more other criteria) with the intermediate data group and by grouping each intermediate-data group with one or more of the SM groups that were not grouped into an MM group in block B310 and that have high correlations with the intermediate-data group. Also, if an intermediate-data group does not have high correlations with any other intermediate-data group or any of the SM groups that were not grouped into an MM group in block B310, then a high-correlation group may contain only the intermediate-data group. Thus a high-correlation group may contain (i) only one intermediate-data group, (ii) multiple intermediate-data groups, or, alternatively, (iii) one or more intermediate-data groups and one or more SM groups that were not grouped into an MM group in block B310.

Furthermore, some embodiments of FIG. 3 (and some embodiments of the other embodiments that are described herein) use other similarity or dissimilarity measures (e.g., Euclidean distances) in addition to, or in alternative to, correlations (intra-group, inter-modality correlations and inter-group correlations). Thus, correlations are an example of similarity measures, and other embodiments use other similarity measures.

For example, some embodiments use correlations or Euclidean distances only when comparing data of the same size (e.g., when comparing two types of data that have the same data size). When comparing different data sizes (e.g., datasets with different data sizes, for example different numbers of records), such embodiments may use one or both of cosine similarity and maximum mean discrepancy (MMD). For example, such embodiments may use one or both of cosine similarity and MMD to compare 50 data sets with 5 features to 100 data sets with 5 features. Also, whether for image data or numerical data (e.g., from blood tests), data similarity can be evaluated by extracting feature vectors from the target data and aligning them to the same scale through a data standardization process (e.g., scaling to −1.0<x<1.0).

For example, the cosine similarity cos(a, b) between a and b may be described by the following:

$$cos ( a , b ) = \frac{a \cdot b}{‖ a ‖ ‖ b ‖} = \frac{{\sum }_{i = 1}^{n} {a}_{i} {b}_{i}}{\sqrt{{\sum }_{i = 1}^{n} {a}_{i}^{2}} \sqrt{{\sum }_{i = 1}^{n} {b}_{i}^{2}}} , \qquad ( 6 )$$

where a result of 1 indicates a perfect similarity, a result of 0 indicates neutrality, and a result of −1 indicates no similarity.

And for example, MMD may generally be described by the following (with kernel function k):

$${MMD}^{2} = \frac{1}{{m}^{2}} {\sum }_{i , j = 1}^{m} k ( {z}_{i} , {z}_{j} ) - \frac{2}{mn} {\sum }_{i , j = 1}^{m , n} k ( {z}_{i} , {x}_{j} ) + \frac{1}{{n}^{2}} {\sum }_{i , j = 1}^{n} k ( {x}_{i} , {x}_{j} ) , \qquad ( 7 )$$

$$k ( x , {x}^{′} ) = exp ( - γ {‖ x - {x}^{′} ‖}^{2} ) .$$

The flow then proceeds to block B325, where the data-processing device generates a respective first classification result for each of the one or more high-correlation groups. Block B325 includes inputting each high-correlation group into an ML model that has been trained to extract and output features based on the inputs. All of the high-correlation groups may be input into the same ML model, or subsets of the high-correlation groups may be input into different ML models. Also, block B325 is a part of intermediate fusion.

Then the flow advances to block B330, where the data-processing device 10 determines whether there is any ‘ungrouped’ SM group, which is an SM group that was not grouped into an MM group in block B310 and was not grouped into a high-correlation group in block B320. If there is no ‘ungrouped’ SM group (B330=No), then the flow advances to block B340. If there is at least one ‘ungrouped’ SM group (B330=Yes), then the flow advances to block B335.

In block B335, the data-processing device 10 generates one or more first classification results based on the ‘ungrouped’ SM groups. When generating a first classification result, the data-processing device 10 uses an early-fusion model, which includes inputting one or more of the ‘ungrouped’ single-modality groups into the early-fusion model. The data-processing device 10 may input each ‘ungrouped’ single-modality group into an early-fusion model without inputting any other ‘ungrouped’ single-modality group with the input ‘ungrouped’ single-modality group (a one-to-one mapping). However, the data-processing device 10 may input multiple ‘ungrouped’ single-modality groups together into the same early-fusion model (a many-to-one mapping). Thus, in block B335, the data-processing device 10 may obtain one or more first classification results.

The flow then moves to block B340, where the data-processing device 10 generates a second classification result based on at least some (e.g., all) of the first classification results that were generated in block B325, and, if block B335 was performed, in block B335. To generate the second classification result, the data-processing device 10 inputs the first classification results into at least one late-fusion model, which outputs the second classification result based on the inputs.

Next, in block B345, the data-processing device 10 stores or outputs the second classification result. The flow then ends in block B350.

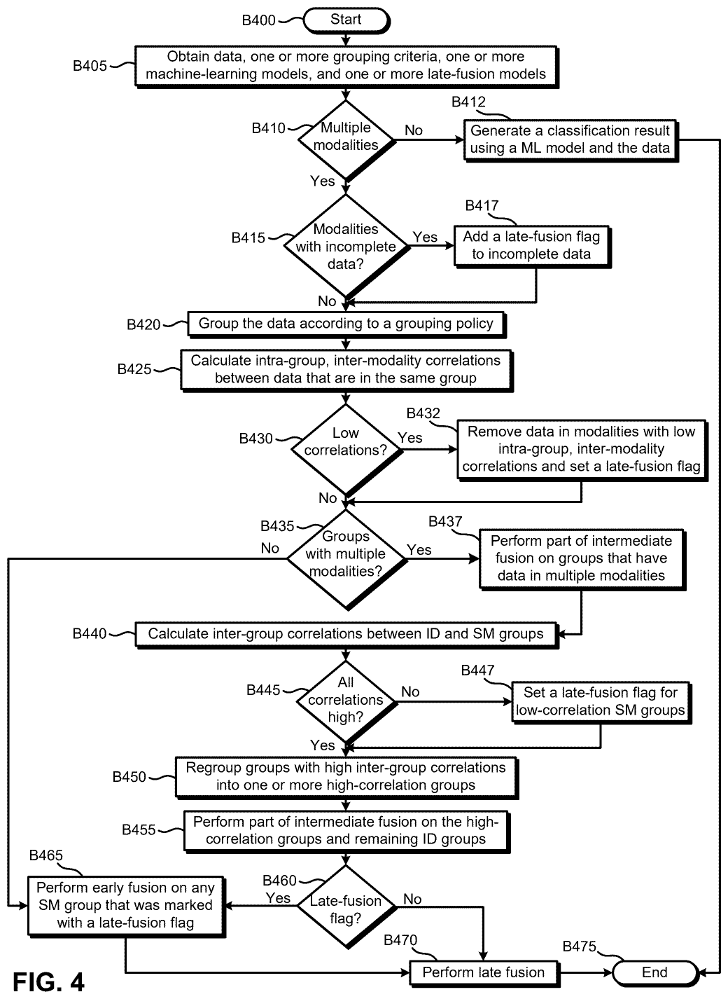

FIG. 4 illustrates an example embodiment of an operational flow for generating a classification result from multiple modalities of data. The flow begins in block B400 and moves to block B405, where a data-processing device 10 obtains data, one or more grouping criteria (as well as other classification settings), one or more machine-learning models (ML models), and one or more late-fusion models. Next, in block B410, the data-processing device 10 determines whether the obtained data include multiple modalities of data.

If the obtained data do not include multiple modalities of data (B410=No), then the flow moves to block B412, where the data-processing device 10 generates a classification result based on the obtained data (which includes data in only one modality). Additionally, early fusion may be performed in block B412. For example, if the obtained data are all in a biomarker modality, but some of the data measure protein biomarkers A, B, and C, and some of the data measure protein biomarkers D, E, and F, then the data will be fused by early fusion in block B412. Then the flow ends in block B475.

If the obtained data do include multiple modalities of data (B410=Yes), then the flow proceeds to block B415.

In block B415, the data-processing device 10 determines whether the data in any of the modalities is incomplete (e.g., whether any SM group has incomplete data). For example, in an SM group, one or more biomarkers may not have been measured, one or more biomarkers may have an invalid quantity (e.g., a negative number), the data for one or more biomarkers may indicate that an error occurred, or some image data may have been omitted. If one or more of the modalities have incomplete data (B415=Yes), then the flow advances to block B417, where the data-processing device 10 adds a late-fusion flag to the incomplete data (e.g., to the SM group that includes the incomplete data). And the flow then moves to block B420. Also, if none of the modalities have incomplete data (B415=No), then the flow proceeds directly to block B420.

In block B420, the data-processing device 10 generates MM groups by grouping the obtained data (e.g., the SM groups) according to a grouping policy, which includes one or more grouping criteria. The grouping may exclude any data that have been marked with a late-fusion flag, and may thus exclude incomplete data.

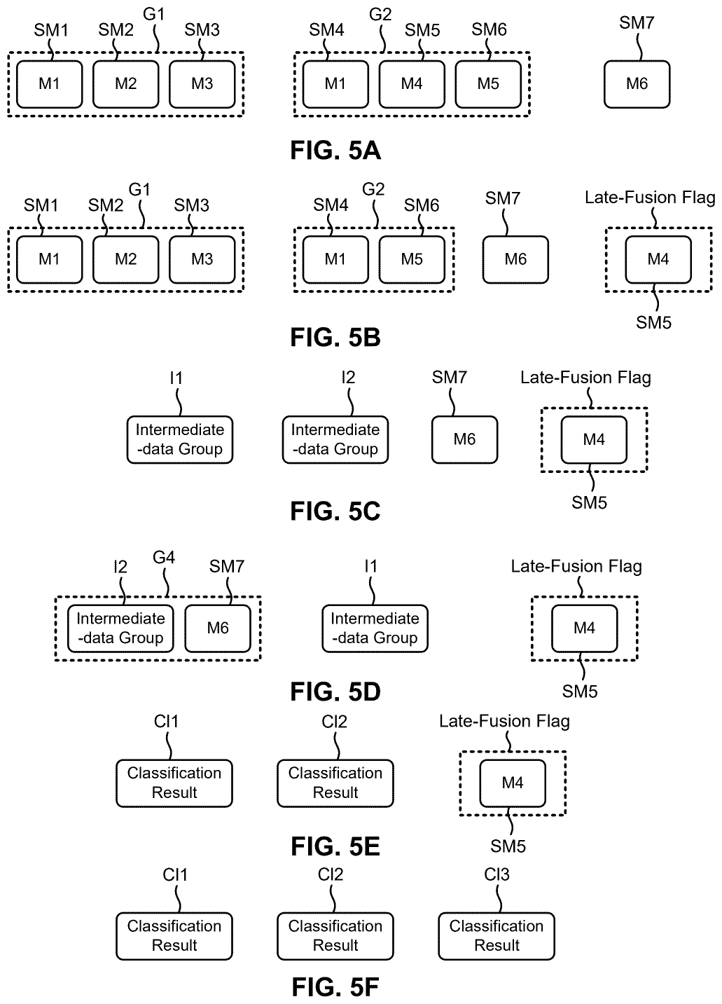

For example, FIG. 5A illustrates examples of MM groups that are formed by grouping data from multiple modalities and an example of an SM group that has not been grouped into an MM group. MM group G1 includes data in modalities M1, M2, and M3, which are in respective SM groups SM1, SM2, and SM3 in this example. MM group G2 includes data in modalities M1, M4, and M5, which are in respective SM groups SM4, SM5, and SM6 in this example. The data in modality M6 are in SM group SM7, which is not grouped with data in another modality. SM group SM1 in MM group G1 may be identical to SM group SM4 in MM group G2, and SM group SM1 in MM group G1 may be different from SM group SM4 in MM group G2.

Next, in block B425, the data-processing device 10 calculates intra-group, inter-modality correlations between the data in the different modalities that are in the same MM group. For example, referring to the embodiment in FIG. 5A, the data-processing device 10 calculates the intra-group, inter-modality correlations between the data in modalities M1, M2, and M3 in MM group G1 and calculates the intra-group, inter-modality correlations between the data in modalities M1, M4, and M5 in MM group G2. For example, the correlations between SM groups SM1, SM2, and SM3 may be calculated, and the correlations between SM groups SM4, SM5, and SM6 may be calculated.

The flow then moves to block B430, where the data-processing device 10 determines whether any of the data in an MM group have low intra-group, inter-modality correlations (i.e., whether any of the data in one modality (e.g., the data in a SM group) in an MM group have inter-modality correlations with the data in other modalities (e.g., the data in SM groups in other modalities) in the MM group that are all below a threshold). If the any of the data in an MM group have low intra-group, inter-modality correlations (B430=Yes), then the flow advances to block B432. In block B432, the data-processing device removes the data (e.g., the SM group) in the modalities that have low correlations from their respective MM groups and sets a late-fusion flag for the removed data (e.g., for the removed SM group).

For example, FIG. 5B illustrates the MM groups from FIG. 5A after the data with low intra-group, inter-modality correlations have been removed. None of the data in MM group G1 had low intra-group, inter-modality correlations, so none of the data have been removed from MM group G1. However, SM group SM5 (the data in modality M4) had low intra-group, inter-modality correlations with SM groups SM4 and SM6 (the data in modalities M1 and M5), although SM groups SM4 and SM6 (the data in modalities M1 and M5) did not have low intra-group, inter-modality correlations with each other. Thus, SM group SM5 (the data in modality M4) has been removed from MM group G2. Also, a late-fusion flag has been set for SM group SM5 (the data in modality M4).

The flow then proceeds to block B435.

If none of the data in an MM group have low intra-group, inter-modality correlations (B430=No), then the flow moves to block B435.

In block B435, the data-processing device 10 determines if any of the MM groups still include data in multiple modalities. If none of the MM groups include data in multiple modalities (B435=No), then the flow moves to block B465.

If one or more of the MM groups still include data in multiple modalities (B435=Yes), then the flow moves to block B437. In block B437, the data-processing device 10 performs part of intermediate fusion on each of the MM groups that still have data in multiple modalities using one or more of the ML models. This part of intermediate fusion outputs groups of intermediate data (intermediate-data (ID) groups).

For example, FIG. 5C illustrates the intermediate-data groups and SM groups after part of intermediate fusion has been performed on the MM groups in FIG. 5B. The data in MM group G1, which include data in modalities M1, M2, and M3, were input into one or more ML models, which generated intermediate-data group 11 based on the data in MM group G1. For example, the one or more ML models may extract features from the data in modalities M1, M2, and M3, and the extracted features may constitute intermediate-data group 11. Also, the data in MM group G2 were input into one or more ML models, which output intermediate-data group 12 based on the data in MM group G2. The SM groups SM5 and SM7 are unchanged.

The flow then moves to block B440.

In block B440, the data-processing device 10 calculates inter-group correlations between the intermediate-data groups and the SM groups that were not grouped into an MM group at the conclusion of block B420. The data-processing device 10 may calculate a respective correlation for some or every pair combination, where each pair includes an intermediate-data group and either another intermediate-data group or an SM group. Thus, every pair includes either (i) two intermediate-data groups or (ii) an intermediate-data group and an SM group. For example, if there are three intermediate-data groups and two SM groups, then the data-processing device 10 may calculate up to nine correlations.

Next, in block B445, the data-processing device 10 determines whether all of the inter-group correlations are high (exceed a threshold). If at least one of the inter-group correlations is not high (B445=No), then the flow proceeds to block B447, where the data-processing device 10 sets a late-fusion flag on any SM group that does not have a high inter-group correlation with an intermediate-data group. And the flow then moves to block B450. If all of the inter-group correlations are high (B445=Yes), then the flow moves to block B450.

In block B450, the data-processing device 10 regroups the intermediate-data groups and SM groups that have high inter-group correlations into one or more high-correlation groups. In some embodiments, all of the intermediate-data groups that have a least one high inter-group correlation are grouped into a single high-correlation group. Also, in some embodiments, a high-correlation group includes only the intermediate-data groups and SM groups that have high inter-group correlations with each other. The high-correlation groups do not include intermediate-data groups and the SM groups that do not have any high inter-group correlations, and a respective late-fusion flag has been set for each of the SM groups that do not have any high inter-group correlations.

For example, FIG. 5D illustrates the intermediate-data groups and the SM groups from FIG. 5C after the intermediate-data groups and the SM groups that have high inter-group correlations have been re-grouped into a high-correlation group. In this example, intermediate-data group 12 had a high inter-group correlation with SM group SM7, but intermediate-data group 11 did not have a high inter-group correlation with any intermediate-data group or SM group. Thus, intermediate-data group 12 and SM group SM7 have been grouped into high-correlation group G4 (revised group G4), and intermediate-data group 11 has not been grouped with any other intermediate-data group or with an SM group.

Then, in block B455, the data-processing device 10 performs part of intermediate fusion on the one or more high-correlation groups by inputting the one or more high-correlation groups into an ML model, which outputs respective first classification results based on the input high-correlation groups. And the data-processing device 10 performs part of intermediate fusion on any remaining intermediate-data groups (the intermediate-data groups that have not been grouped into a high-correlation group) by inputting the remaining intermediate-data groups into an ML model, which outputs respective first classification results based on the input intermediate-data groups. Thus, block B455 completes the intermediate fusion that was started in block B437.

For example, FIG. 5E illustrates first classification results that were generated based on the high-correlation group and the intermediate-data group in FIG. 5D, as well as an SM group. The data in high-correlation group G4, which include intermediate-data group 12 and SM group SM7, were input into an ML model, which generated and output first classification result Cl1 based on the data in high-correlation group G4. Before an SM group is input into the ML model in block B455, the data-processing device 10 may perform preprocessing on the SM group to put the data in a format that is accepted by the ML model. Also, the data-processing device may use an ML model that accepts the data as is. And intermediate-data group 11 was input into an ML model, which generated and output first classification result Cl2 based on the data in intermediate-data group 11.

The flow then advances to block B460, where the data-processing device 10 determines whether the late-fusion flag has been set for any SM group. If the late-fusion flag has been set for at least one SM group (B460=Yes), then the flow moves to block B465.

In block B465, the data-processing device 10 performs early fusion on any SM group that was marked with a late-fusion flag, and thus the data-processing device 10 uses one or more early-fusion models to generate one or more first classification results based on any SM group that was marked with a late-fusion flag. For example, FIG. 5F illustrates first classification results Cl1 and C2 that were generated based on the high-correlation group and the intermediate-data group in FIG. 5D and a first classification result Cl3 that was generated based on the SM group in FIG. 5E that was marked with a late-fusion flag. Because SM group SM5 was marked with a late-fusion flag (which may identify ‘ungrouped’ SM groups), the data-processing device 10 used an early-fusion model to generate first classification result Cl3 based on SM group SM5.

If the late-fusion flag has not been set for at least one SM group (B460=No), then the flow moves to block B470.

Then, in block B470, the data-processing device 10 performs late fusion using one or more late-fusion models, any classification results that were generated in block B455, and any classification results that were generated in block B465. For example the data-processing device may generate a second classification result based on first classification results Cl1, Cl2, and Cl3 in FIG. 5F.

Finally, in block B475, the data-processing device 10 stores or outputs the second classification result (and, in some embodiments, the first classification results), and the flow ends.

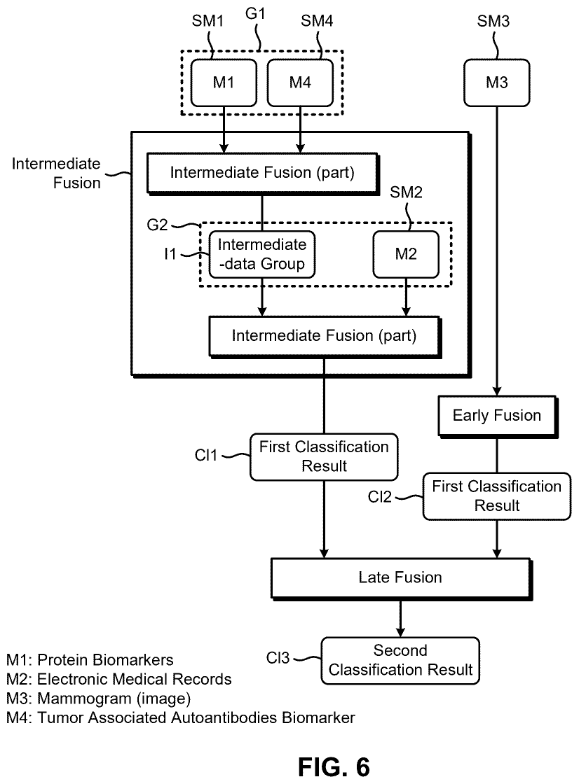

FIG. 6 illustrates an example embodiment of the grouping and fusion of multiple modalities of data. Initially, data are obtained in the following modalities: protein biomarker, which is modality M1; electronic medical records (EMR), which is modality M2; mammogram, which is modality M3; and tumor associated antibodies biomarkers, which is modality M4. The data in modality M1 are included in SM group SM1, the data in modality M2 are included in SM group SM2, data in modality M3 are included in SM group SM3, and data in modality M4 are included in SM group SM4.

A grouping policy include grouping criteria that group M1 (protein biomarkers) and M4 (tumor associated antibodies biomarkers) because they both belong to the same proteomics category. Accordingly, a data-processing device 10 groups SM group SM1 with SM group SM4, thereby forming MM group G1 (B210 in FIG. 2, B310 in FIG. 3, B420 in FIG. 4). Additionally, the intra-group, inter-modality correlations between the data in M1 and M4 may exceed a threshold (B425-B432 in FIG. 4).

The data-processing device then performs intermediate fusion on MM group G1. Intermediate fusion includes performing two parts. The data-processing device performs one part of intermediate fusion on MM group G1, which produces intermediate-data group 11 (B215 in FIG. 2, B315 in FIG. 3, B437 in FIG. 5). And the data-processing device re-groups intermediate-data group 11 and SM group SM2 into high-correlation group G2 (B215 in FIG. 2, B320 in FIG. 3, B450 in FIG. 4). Also, as part of the regrouping, the data-processing device may determine that intermediate-data group 11 and SM group SM2, which includes the data in modality M2, have a high inter-group correlation (B320 in FIG. 3, B440 in FIG. 4). Additionally, the data-processing device sets a late-fusion flag for SM group SM3, which includes the data in modality M3 (B247 in FIG. 2). The late-fusion flag may be an indication of an ‘ungrouped’ SM group.

Then the data-processing device then performs another part of intermediate fusion on the data in high-correlation group G2, which generates first classification result Cl1 (B215 in FIG. 2, B325 in FIG. 3, B455 in FIG. 4).

The data-processing device then generates a respective first classification result for each ‘ungrouped’ SM group, and thus generates a respective classification result Cl2 for SM group SM3 (early fusion) (B220-B225 in FIG. 2, B330-B335 in FIG. 3, B460-B465 in FIG. 4). For example, the data-processing device may determine that a SM group is ‘ungrouped’ if a late-fusion flag has been set for the SM group.

Finally, the data-processing device generates a second classification result Cl3 based on first classification results Cl1 and Cl2 (late fusion) (B230 in FIG. 2, B340 in FIG. 3, B470 in FIG. 4).

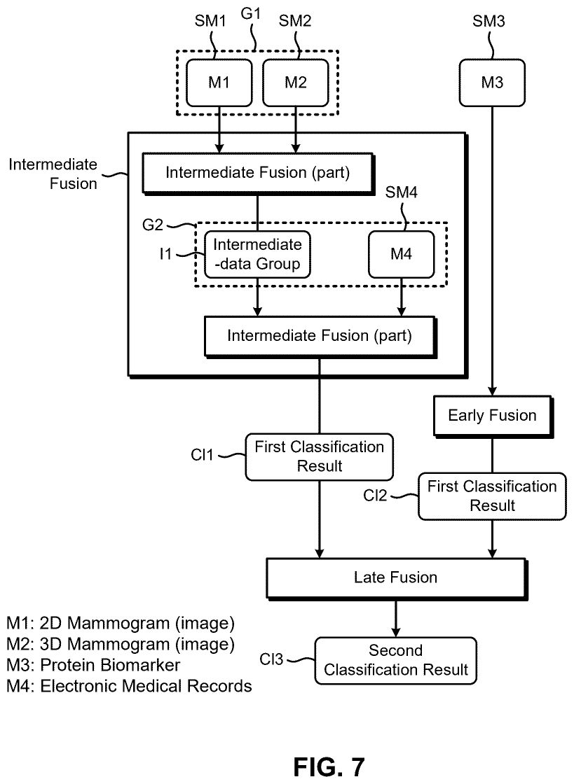

FIG. 7 illustrates an example embodiment of the grouping and fusion of multiple modalities of data. Initially, data are obtained in the following modalities: 2D mammogram, which is modality M1; PET, which is modality M2; protein biomarker, which is modality M3; and EMR, which is modality M4. The data in modality M1 are included in SM group SM1, the data in modality M2 are included in SM group SM2, data in modality M3 are included in SM group SM3, and data in modality M4 are included in SM group SM4.

A grouping policy groups M1 (2D mammogram) and M2 (PET) because they both belong to a radiomic group. Accordingly, a data-processing device 10 groups SM group SM1 with SM group SM2, thereby forming MM group G1 (B210 in FIG. 2, B310 in FIG. 3, B420 in FIG. 4). Additionally, the intra-group, inter-modality correlations between SM group SM1 and SM group SM2 may exceed a threshold (B425-B432 in FIG. 4).

The data-processing device then performs intermediate fusion using MM group G1, which includes performing two parts. The data-processing device performs one part of intermediate fusion on MM group G1, which produces intermediate-data group 11 (B215 in FIG. 2, B315 in FIG. 3, B437 in FIG. 5).

The data-processing device then re-groups intermediate-data group 11 and SM group SM4 into high-correlation group G2 (B215 in FIG. 2, B320 in FIG. 3, B450 in FIG. 4). As part of the regrouping, the data-processing device may determine that intermediate-data group 11 and SM group SM4, which includes the data in modality M4, have a high inter-group correlation (B320 in FIG. 3, B440 in FIG. 4). Additionally, the data-processing device may set a late-fusion flag for SM group SM3, which includes the data in modality M3 (B247 in FIG. 2). The late-fusion flag may be an indication of an ‘ungrouped’ SM group.

Then the data-processing device performs another part of intermediate fusion on the data in high-correlation group G2, which generates a first classification result Cl1 (B215 in FIG. 2, B325 in FIG. 3, B455 in FIG. 4).

The data-processing device then generates a respective first classification result for each ‘ungrouped’ SM group, and thus generates a respective first classification result Cl2 for SM group SM3 (early fusion) (B220-B225 in FIG. 2, B330-B335 in FIG. 3, B460-B465 in FIG. 4).

Finally, the data-processing device generates a second classification result Cl3 based on the first classification results Cl1 and Cl2 (late fusion) (B230 in FIG. 2, B340 in FIG. 3, B470 in FIG. 4).

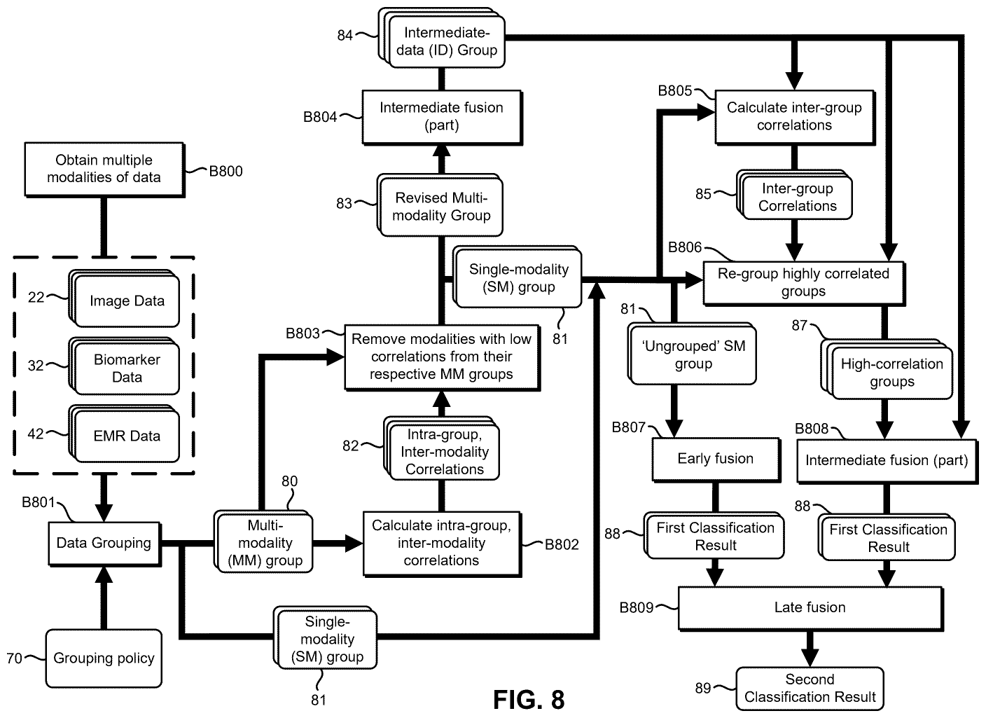

FIG. 8 illustrates the flow of information in a method for generating a classification result from multiple modalities of data that can be performed by a data-processing device. Multiple modalities of data, examples of which include image data 22, biomarker data 32, and EMR data 42, are obtained in block B800. In block B801, the obtained data and a grouping policy 70 are used to perform data grouping. The data grouping in block B801 generates MM groups 80 based on the input data and the grouping policy 70. Also, some ungrouped SM groups 81 may remain after block B801.

Then, in block B802, intra-group, inter-modality correlations 82 are calculated based on the MM groups 80. Next, in block B803, data (e.g., SM groups) in modalities with low intra-group, inter-modality correlations 82 are removed from their respective MM groups 80, which generates revised MM groups 83 (the groups that still include multiple modalities of data after the data are removed) and SM groups 81 that are constituted by the SM groups with low intra-group, inter-modality correlations 82 that are removed from the MM groups 80.

Then, in block B804, a part of intermediate fusion is performed on the revised MM groups 83, which generates one or more intermediate-data groups 84 from the revised MM groups 83.

Next, in block B805, inter-group correlations 85 are calculated based on the SM groups 81 and on the one or more intermediate-data groups 84.

And then, in block B806, based on the inter-group correlations 85, the highly correlated intermediate-data groups 84 and SM groups 81 are re-grouped into one or more high-correlation groups 87. Late-fusion flags are set for the ‘ungrouped’ SM groups 81 (SM groups that are not grouped with any other group).

In block B807, early fusion is performed on the ‘ungrouped’ SM groups 81. The early fusion outputs one or more first classification results 88 based on the ‘ungrouped’ SM groups 81. And in block B808, part of intermediate fusion is performed on the high-correlation groups 86 and part of intermediate fusion is performed on any of the intermediate-data groups 84 that are not included in a high-correlation group, which generates first classification results 88 (e.g., a respective classification result 88 for each high-correlation group 86 and a respective classification result 88 for each intermediate-data group 84 that is not included in a high-correlation group).

Finally, in block B809, late fusion is performed based on all of the first classification results 88, which generates a second classification result 89. Also, late fusion is performed only if there are two or more first classification results. If there is only one first classification result 88, then the one first classification result 88 is used as the second classification result 89.

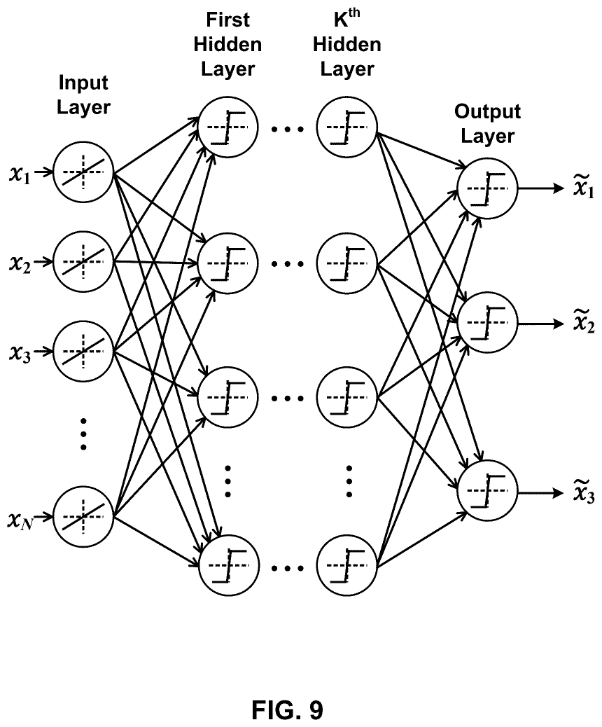

As noted above, some of the ML models may be neural networks. FIG. 9 illustrates an example embodiment of a neural network. The neural network is an artificial neural network (ANN) having N inputs, K hidden layers, and three outputs. Each layer is made up of nodes (also called neurons), and each node performs a weighted sum of the inputs and compares the result of the weighted sum to a threshold to generate an output. ANNs make up a class of functions for which the members of the class are obtained by varying thresholds, connection weights, or specifics of the architecture, such as the number of nodes or their connectivity. The nodes in an ANN can be referred to as neurons (or as neuronal nodes), and the neurons can have inter-connections between the different layers of the ANN system. The simplest ANN has three layers, and is called an autoencoder. The neural network may have more than three layers of neurons, and may have as many output neurons \tilde{x}_{N} as input neurons. The synapses (i.e., the connections between neurons) store values called “weights” (also interchangeably referred to as “coefficients” or “weighting coefficients”) that manipulate the data in the calculations. The outputs of the ANN depend on three types of parameters: (i) the interconnection pattern between the different layers of neurons, (ii) the learning process for updating the weights of the interconnections, and (iii) the activation function that converts a neuron's weighted input to its output activation.

Mathematically, a neuron's network function m(x) can be described as a composition of other functions nᵢ(x), which can further be described as a composition of other functions. This can be conveniently represented as a network structure, with arrows depicting the dependencies between variables, as shown in FIG. 9. For example, the ANN can use a nonlinear weighted sum, such as m(x)=K(Σᵢwᵢnᵢ(x)), where K (commonly referred to as the activation function) is some predefined function (e.g., a hyperbolic tangent), and where wᵢ is the weight of corresponding function nᵢ(x).

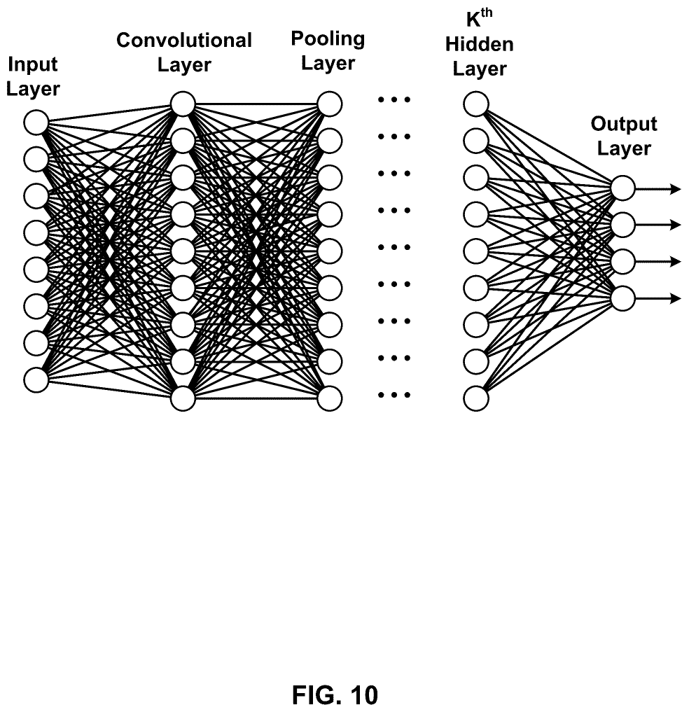

In FIG. 9 (and similarly in FIG. 10), the neurons (i.e., nodes) are depicted by circles around a threshold function. For the non-limiting example shown in FIG. 9, the inputs are depicted as circles around a linear function, and the arrows indicate directed connections between neurons. In certain implementations, the neural network is a feedforward network as exemplified in FIGS. 9 and 10 (e.g., it can be represented as a directed acyclic graph).

The neural network operates to achieve a specific task, such as resampling data or refining a pathlength, by searching within the class of functions F to learn, using a set of observations, to find m*∈F, which solves the specific task in some optimal sense (e.g., the stopping criteria discussed above). For example, in certain implementations, this can be achieved by defining a cost function C: F→R such that, for the optimal solution m*, C(m*)≤C(m)∀m∈F (i.e., no solution has a cost less than the cost of the optimal solution). The cost function is a measure of how far away a particular solution is from an optimal solution to the problem to be solved (e.g., the error). Learning algorithms iteratively search through the solution space to find a function that has the smallest possible cost. In certain implementations, the cost is minimized over a sample of the data (i.e., the training data).

In some embodiments, the neural network is a convolutional neural network (CNN), and FIG. 10 illustrates an example embodiment of a CNN. CNNs use feed-forward ANNs in which the connectivity pattern between neurons can represent convolutions. For example, CNNs can be used for image-processing optimization by using multiple layers of small neuron collections that process portions of the input data (e.g., projection data), called receptive fields. The outputs of these collections can then be tiled so that they overlap. This processing pattern can be repeated over multiple layers having alternating convolution and pooling layers.

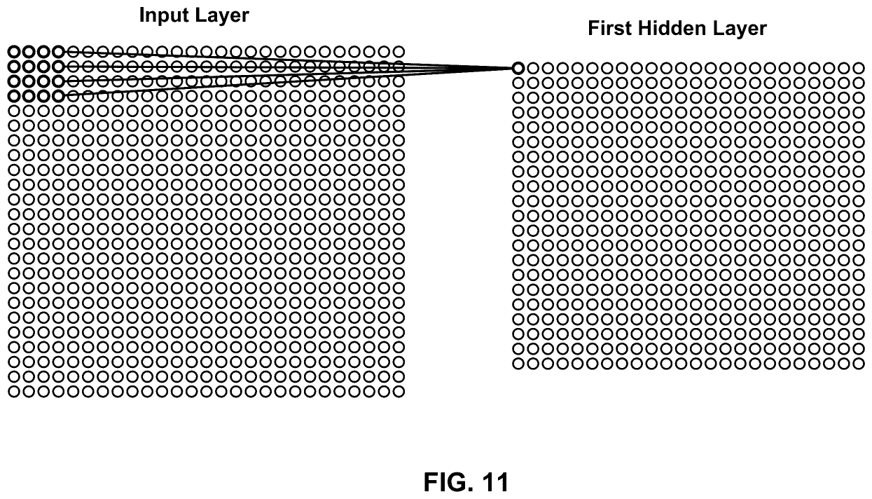

FIG. 11 illustrates an example of implementing a convolution layer for one neuronal node of the convolution layer, according to an example embodiment. FIG. 11 shows an example of a 4×4 kernel being applied to map values from an input layer representing a two-dimensional image (e.g., a sinogram) to a first hidden layer, which is a convolution layer. The kernel maps respective 4×4 pixel regions to corresponding neurons of the first hidden layer.

Following a convolution layer, a CNN can include local or global pooling layers, which combine the outputs of neuron clusters in the convolution layers. Additionally, in certain implementations, the CNN can also include various combinations of convolution and fully-connected layers, with pointwise nonlinearity applied at the end of or after each layer.

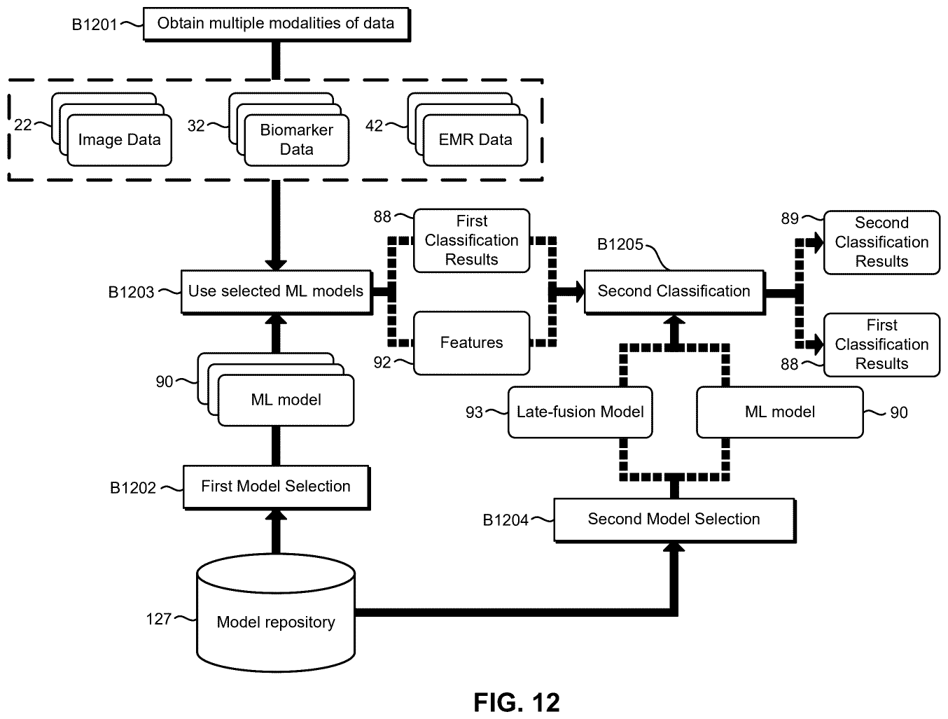

FIG. 12 illustrates the flow of information in a method for generating a classification result from multiple modalities of data.

In block B1201, a data-processing device 10 obtains multiple modalities of data.

In block B1202, the data-processing device 10 performs a first model selection. In the first model selection, the data-processing device 10 selects one or more machine-learning (ML) models 90 from a model repository 127, which may be in the data-processing device 10. Also, the model repository 127 may be in an external device (external to the data-processing device 10), and the data-processing device 10 may select and obtain the one or more ML models 90 from the external device via one or more electrical connections, such as network connections.

In block B1203, the data-processing device 10 inputs at least some of the image data 22, the biomarker data 32, and the EMR data 42 into the selected ML models 90. Each of the ML models 90 may accept inputs in only one modality of data (e.g., early-fusion models). And, of the data in the accepted modality, an ML model 90 may accept a subset of the data. For example, one of the ML models 90 may accept a subset of the image data as inputs, and another of the ML models 90 may accept a subset of the biomarker data as inputs. Also for example, some of the ML models 90 may accept the same inputs as one of the classification models that are described above in Table 1.

Additionally, the ML models 90 may be early-fusion models, for example classification models, which operate as classifiers and which output first classification results 88. And the ML models 90 may be artificial neural networks (neural networks) that output features 92.

Next, in block B1204, the data-processing device 10 performs second model selection. In the second model selection, the data-processing device 10 selects an ML model 90 or a late-fusion model 93 from the model repository 127. The data-processing device 10 selects the ML model 90 or the late-fusion model 93 based on one or more of the following: the obtained data, the ML models 90 that were selected in the first model selection in block B1202, the outputs of the ML models 90 that were selected in the first model selection in block B1202 (which are first classification results 88 or features 92), and the classification objective (e.g., the condition being diagnosed). For example, if the outputs of the ML models 90 that were selected in the first model selection in block B1202 are features 92, then, in block B1204, the data-processing device 10 selects an ML model that accepts features 92 as inputs. But, if the outputs of the ML models 90 that were selected in the first model selection in block B1202 are first classification results 88, then, in block B1204, the data-processing device 10 selects a late-fusion model 93.

Then, in block B1205, the data-processing device 10 uses the features 92 that were generated in B1203 as the inputs of the ML model 90 that was selected in block B1204 to perform a classification or uses the first classification results 88 that were generated in block B1203 as the inputs of the late-fusion model 93 that was selected in block B1204 to perform a final classification. The classification in block B1205 outputs a second classification result 89 if a late-fusion model 93 is used in block B1205 and outputs a first classification result 88 if an ML model 90 is selected in block B1204.

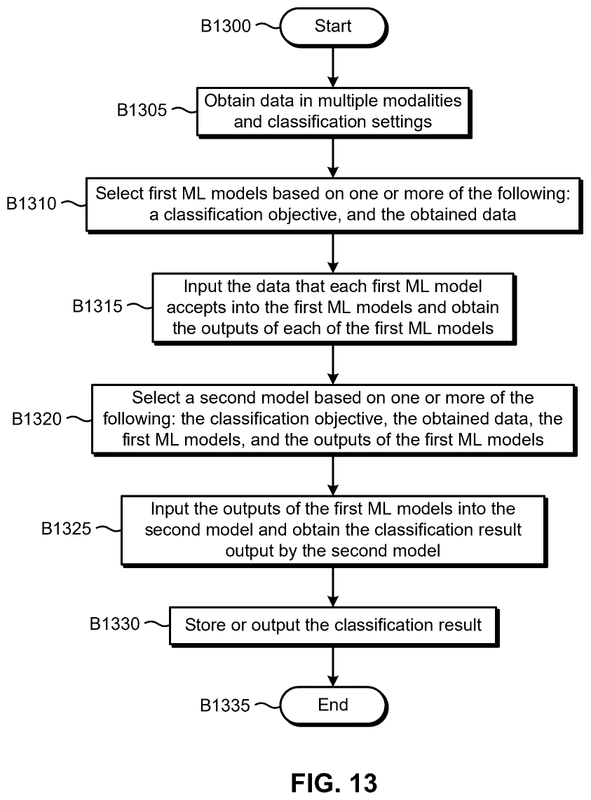

FIG. 13 illustrates an example embodiment of an operational flow for generating a classification result from multiple modalities of data. The flow begins in block B1300 and then moves to block B1305, where a data-processing device obtains data in multiple modalities (e.g., image data and biomarker data) and classification settings, which indicate at least one classification objective (e.g., a disease or condition that is being diagnosed). The flow then moves to block B1310, where the data-processing device selects one or more first ML models based on one or more of the following: the classification objective, and the obtained data. The first ML models may be early-fusion models or intermediate-fusion models that output features.

Next, in block B1315, the data-processing device inputs the data, of the obtained data, that each first ML model accepts into the first ML models and obtains the outputs of each of the first ML models.

Then, in block B1320, the data-processing device selects a second model based on one or more of the following: the at least one classification objective, the obtained data, the first ML models, and the outputs of the first ML models. The second model may be a late-fusion model. Also, the second model may be an ML model that accepts features as inputs, such as an ML model that is part of an intermediate-fusion model.

The flow then advances to block B1325, where the data-processing device inputs the outputs of the first ML models into the second model and obtains the classification result that is output by the second model. If the second model is a late-fusion model, then the classification result is a second classification result. If the second model is an ML model that is part of an intermediate-fusion model, then the classification result is a first classification result. In block B1330, the data-processing device stores or outputs the second classification result. And then the flow ends in block B1335.

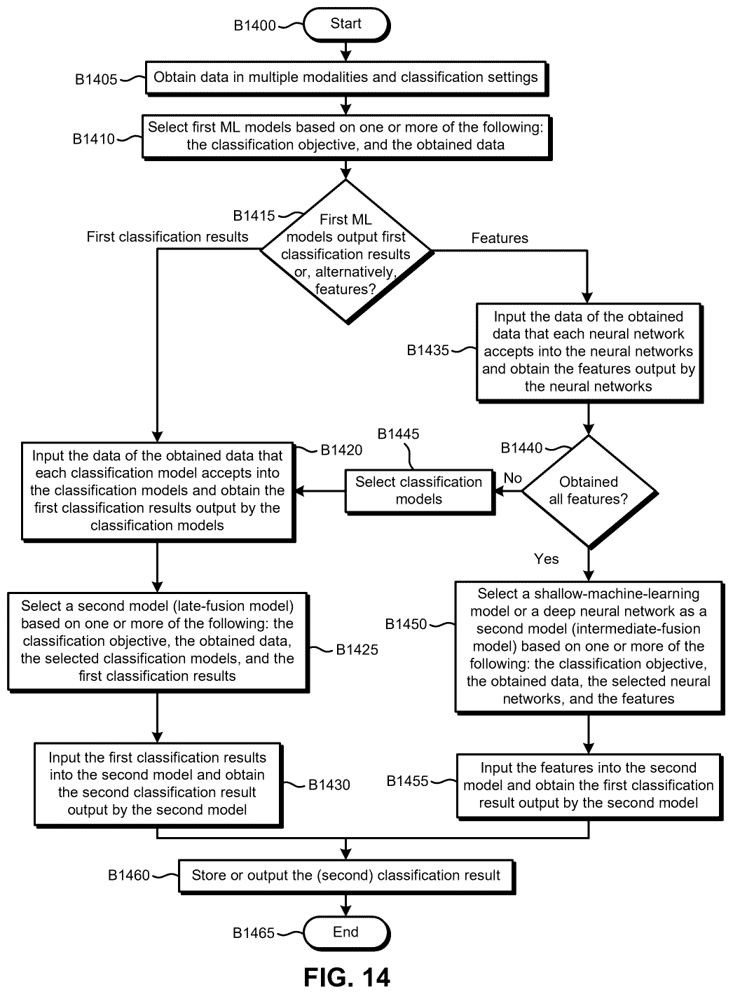

FIG. 14 illustrates an example embodiment of an operational flow for generating a classification result from multiple modalities of data. The flow begins in block B1400 and then moves to block B1405, where a data-processing device obtains data in multiple modalities (e.g., image data and biomarker data) and classification settings, which indicate at least one classification objective (e.g., a condition that is being diagnosed). The flow then moves to block B1410, where the data-processing device selects one or more first ML models based on one or more of the following: the at least one classification objective (e.g., a condition that is being diagnosed), and the obtained data. The one or more first ML models may be early-fusion models or intermediate-fusion models.

The flow then proceeds to block B1415, where the data-processing device determines whether the one or more first ML models output first classification results or, alternatively, features. If the one or more first ML models output first classification results (B1415=first classification results), and are thus classification models (which are early-fusion models), then the flow moves to block B1420. If the one or more first ML models output features, and are thus neural networks that are trained to extract features (and also intermediate-fusion models), then the flow proceeds to block B1435.

In block B1420, the data-processing device inputs the data of the obtained data that each classification model accepts into the classification models and obtains the first classifications results that are output by the classification models. Then, in block B1425, the classification model selects, as a second model, a late-fusion model. The second model is selected based on one or more of the following: the at least one classification objective, the obtained data, the selected classification models, and the first classification results.

Next, in block B1430, the data-processing device inputs the first classification results into the second model and obtains the second classification result that is output by the second model. The flow then moves to block B1460.

If the flow moves from block B1415 to block B1435 (B1415=features), then in block B1435 the data-processing device inputs the data, of the obtained data, that each of the one or more neural networks accepts into the one or more neural networks and obtains the features that are output by the one or more neural networks.

In block B1440, the data-processing device determines whether all of the features that were expected to be output by the one or more neural networks were obtained in block B1435. For example, the data-processing device may determine whether all features that are required as inputs for a second model (that is an ML model) were obtained. If all such features were not obtained (B11440=No), then the flow proceeds to block B1445, where the data-processing device selects one or more classification models as the first ML models. The one or more classification models are selected based on one or more of the following: the at least one classification objective, and the obtained data. The flow then proceeds to block B1420. If all expected features were obtained (B1440=Yes), then the flow moves to block B1450.

In block B1450, the data-processing device selects, as a second model, a shallow-machine-learning model or a deep neural network based on one or more of the following: the at least one classification objective, the obtained data, the neural networks that were used in block B1435, and the features that were obtained in block B1435. Then, in block B1455, the data-processing device inputs the features into the second model and obtains the first classification result that is output by the second model. The flow then advances in block B1460.

In block B1460, the data-processing device stores or outputs the classification result, which is a second classification result if block B1430 was performed and which is a first classification result if block B1455 was performed. And the flow ends in block B1465.

Thus, when performing blocks B1435-B1455, the data-processing device performs intermediate fusion, and the classification result of the intermediate fusion is the classification result. However, if in block B1440 the data-processing device determines that all expected features are not obtained (which may indicate that features necessary for the second ML model in the intermediate fusion were not obtained), the data-processing device then switches to blocks B1420-B1430, where the data-processing device performs early fusion and then late fusion.

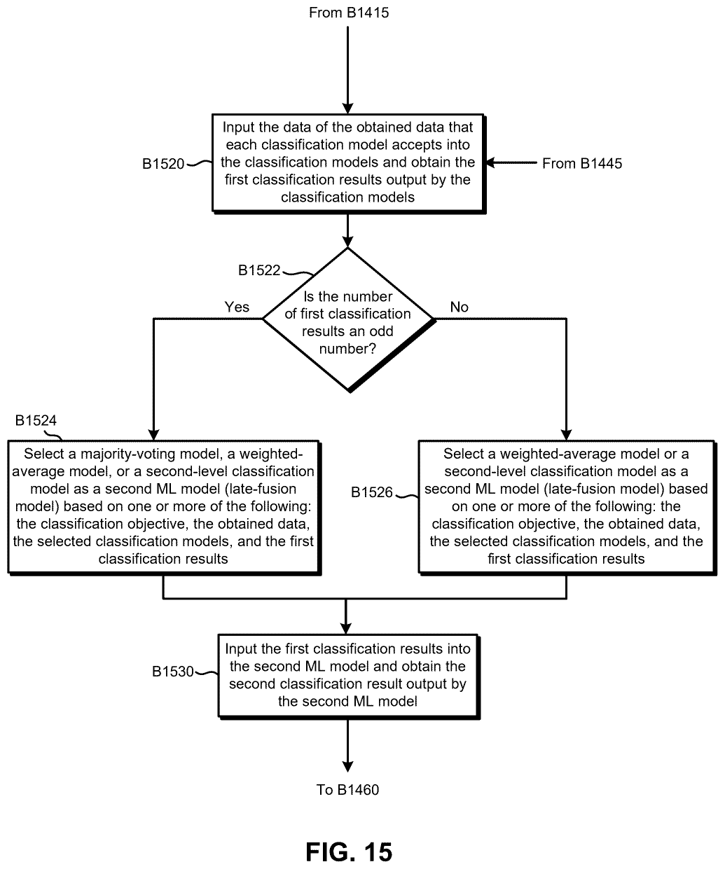

FIG. 15 illustrates an example embodiment of operations that can be substituted for blocks B1420-B1430 in FIG. 14, for example when a hard-voting majority-voting model is used as the late-fusion model. From block B1415 or block B1445, the flow moves to block B11520. In block B11520, a data-processing device inputs the data of the obtained data that each classification model accepts into the classification models and obtains the first classifications results that are output by the classification models.

Next, in block B1522, the data-processing device determines whether the number of first classification results is an odd number.

If the number of first classification results is an odd number (B11522=Yes), then the flow proceeds to block B11524. And, in some embodiments, the odd number must be three or greater for the flow to proceed to block B11524.

In block B1524, the data-processing device selects a majority voting model, a weighted-average model, or a second-level classification model as a second model (late-fusion model) based on one or more of the following: the at least one classification objective, the obtained data, the selected classification models, and the first classification results. The flow then advances to block B1530.

If the number of first classification results is an even number (B11522=No) (or, in some embodiments, is an odd number that is less than three), then the flow proceeds to block B11526. In block B11526, the data-processing device selects a weighted-average model or a second-level classification model as a second model (late-fusion model) based on one or more of the following: the at least one classification objective, the obtained data, the selected classification models, and the first classification results. The flow then advances to block B1530.

In block B1530, the data-processing device inputs the first classification results into the second model and obtains the second classification result that is output by the second model. The flow then moves to block B1460.

Thus, in FIG. 15, the data-processing device will not select a majority-voting model as the second model if the number of first classification results is not an odd number.

Also, in block B1522, if the number of classification results is less than a threshold (e.g., 2, 3, 4, 5), then some embodiments of the data-processing device generate an error notification and end the operational flow.

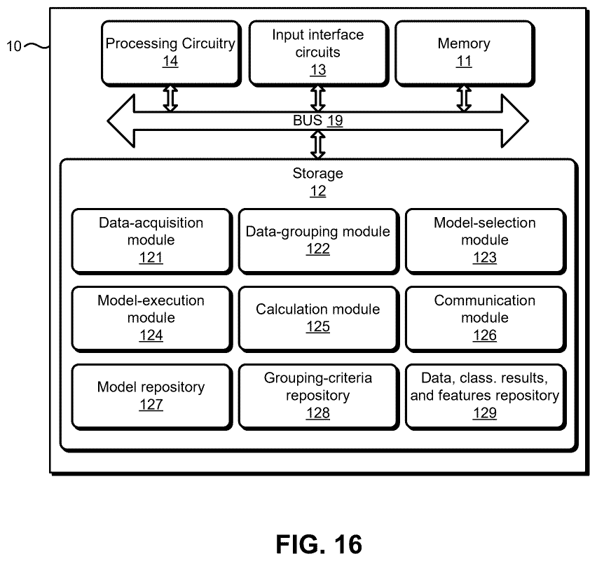

FIG. 16 illustrates an example embodiment of a data-processing device 10. The data-processing device 10 includes processing circuitry 14, one or more input interface circuits 13, memory 11, and storage 12. Also, the hardware components of the data-processing device 10 communicate via one or more buses 19 or other electrical connections. Examples of buses 19 include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more input interface circuits 13 include communication components (e.g., a GPU, a network-interface controller, electrical interfaces) that communicate with the display 42, the gantry 10, a network (not illustrated), and other input or output devices (not illustrated), which may include a keyboard, a mouse, a printing device, a touch screen, a light pen, an optical-storage device, a scanner, a microphone, a drive, a joystick, and a control pad, for example.

The storage 12 includes one or more computer-readable storage media. As used herein, a computer-readable storage medium is a computer-readable medium that includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 12, which may include both ROM and RAM, can store computer-readable data or computer-executable instructions. Also, the storage 12 is an example of a storage unit.

The memory 11 includes one or more computer-readable storage media (e.g., RAM), and the memory 11 provides a work area for the processing circuitry 14.

The data-processing device 10 additionally includes a data-acquisition module 121, a data-grouping module 122, an ML-model-selection module 123, an ML-model-execution module 124, a calculation module 125, and a communication module 126. A module includes logic, computer-readable data, or computer-executable instructions. In the embodiment shown in FIG. 16, the modules are implemented in software (e.g., Assembly, C, C++, C#, Java, BASIC, Perl, Visual Basic, Python). However, in some embodiments, the modules are implemented in hardware (e.g., customized circuitry) or, alternatively, a combination of software and hardware. When the modules are implemented, at least in part, in software, then the software can be stored in the storage 12. Also, in some embodiments, the data-processing device 10 includes additional or fewer modules, the modules are combined into fewer modules, or the modules are divided into more modules. Furthermore, the storage 12 includes a model repository 127, which stores machine-learning models and late-fusion models; a grouping-criteria repository 128, which stores grouping criteria (e.g., grouping policies); and a data, classification results, and features repository 129, which stores obtained and generated data, classification results, and features that are extracted from data using ML models.

The data-acquisition module 121 includes instructions that cause the applicable components (e.g., the processing circuitry 14, the input interface circuit 13, the memory 11) of the data-processing device 10 to obtain data in multiple modalities. For example, some embodiments of the data-acquisition module 121 include instructions that cause the applicable components of the data-processing device 10 to perform at least some of the operations that are described in block B205 in FIG. 2, in block B305 in FIG. 3, in block B405 in FIG. 4, in block B1201 in FIG. 12, in block B1305 in FIG. 13, and in block B1405 in FIG. 14. And the applicable components operating according to the data-acquisition module 121 realize an example of a data-acquisition unit.

The data-grouping module 122 includes instructions that cause the applicable components (e.g., the processing circuitry 14, the input interface circuit 13, the memory 11) of the data-processing device 10 to group data into multi-modality (MM) groups according to one or more grouping criteria, which may be included in grouping policies; to remove data with low intra-group, inter-modality correlations from MM groups; and to generate groups (e.g., high-correlation groups) that include multiple intermediate-data groups or that include at least one intermediate-group with at least one single-modality (SM) group. For example, some embodiments of the data-grouping module 122 include instructions that cause the applicable components of the data-processing device 10 to perform at least some of the operations that are described in block B210 in FIG. 2; in blocks B310 and B320 in FIG. 3; in blocks B420, B432, and B450 in FIG. 4; and in blocks B1, B3, and B6 in FIG. 8. And the applicable components operating according to the data-grouping module 122 realize an example of a data-grouping unit.

The model-selection module 123 includes instructions that cause the applicable components (e.g., the processing circuitry 14, the input interface circuit 13, the memory 11) of the data-processing device 10 to select one or more machine-learning models or one or more late-fusion models based on one or more criteria and to add late-fusion flags to data based on one or more criteria. Examples of the criteria include the following: obtained data (e.g., the modalities of obtained data, the content of obtained data), a classification objective, previously selected ML models, and outputs of other ML models. For example, some embodiments of the model-selection module 123 include instructions that cause the applicable components of the data-processing device 10 to perform at least some of the operations that are described in blocks B220-B225 in FIG. 2; in blocks B330-B335 in FIG. 3; in blocks B410-B417, B432, B447, and B455-B470 in FIG. 4; in blocks B1202 and B1204 in FIG. 12; in blocks B1310 and B1320 in FIG. 13; in blocks B1410, B1425, B1445, and B1450 in FIG. 14; and in blocks B1522, B11524, and B11526 in FIG. 15. And the applicable components operating according to the model-selection module 123 realize an example of a model-selection unit.

The model-execution module 124 includes instructions that cause the applicable components (e.g., the processing circuitry 14, the input interface circuit 13, the memory 11) of the data-processing device 10 to input data into one or more ML models or into one or more late-fusion models, to execute the ML models or late-fusion models, to obtain the outputs of the ML models or late-fusion models, and to store the outputs of the ML models or late-fusion models in the data, classification results, and features repository 129. For example, some embodiments of the model-execution module 124 include instructions that cause the applicable components of the data-processing device 10 to perform at least some of the operations that are described in blocks B215 and B225-B235 in FIG. 2; in blocks B315, B325, B335, B340, and B345 in FIG. 3; in blocks B412, B437, B455, B465, and B470 in FIG. 4; in blocks B4, B7, B8, and B9 in FIG. 8; in blocks B1203 and B1205 in FIG. 12; in blocks B1315 and B1325 in FIG. 13; in blocks B1420, B1430, B1435, and B1455 in FIG. 14; and in blocks B1520 and B11530 in FIG. 15. And the applicable components operating according to the model-execution module 124 realize an example of a model-execution unit.

The calculation module 125 includes instructions that cause the applicable components (e.g., the processing circuitry 14, the input interface circuit 13, the memory 11) of the data-processing device 10 to calculate intra-group, inter-modality correlations between data in groups and to calculate inter-group correlations between data in different groups (intermediate-data groups and single-modality groups). For example, some embodiments of the calculation module 125 include instructions that cause the applicable components of the data-processing device 10 to perform at least some of the operations that are described in block B320 in FIG. 3, in blocks B425 and B440 in FIG. 4, and in blocks B2 and B5 in FIG. 8. And the applicable components operating according to the calculation module 125 realize an example of a calculation unit.

The communication module 126 includes instructions that cause the applicable components (e.g., the processing circuitry 14, the input interface circuit 13, the memory 11) of the data-processing device 10 to communicate with other devices, such as other computing devices (e.g., consoles, servers, databases, terminals), input devices, and output devices; to obtain grouping criteria, ML models, late-fusion models, and classification settings; and to output second classification results. And the applicable components operating according to the communication module 126 realize an example of a communication unit. Also, when controlling a display on a display device (e.g., to display classification results), the applicable components operating according to the communication module 126 realize an example of a display-control unit. Furthermore, when receiving classification settings (e.g., grouping criteria, classifications objectives) from an input device, the applicable components operating according to the communication module 126 realize an example of a configuration unit.

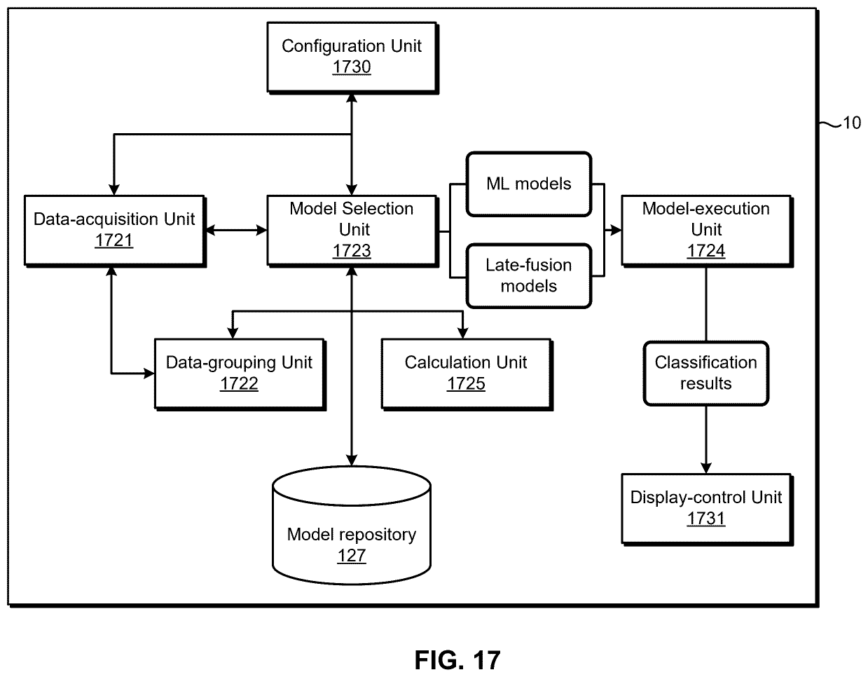

FIG. 17 illustrates the functional configuration of an example embodiment of a data-processing device 10. The data-processing device 10 includes a data-acquisition unit 1721, a data-grouping unit 1722, a model-selection unit 1723, a model-execution unit 1724, a calculation unit 1725, a configuration unit 1726, a display-control unit 1731, and a model repository 127.

The data-acquisition unit 1721 obtains data in multiple modalities. For example, some embodiments of the data-acquisition unit 1721 perform at least some of the operations that are described in block B205 in FIG. 2, in block B305 in FIG. 3, in block B405 in FIG. 4, in block B1201 in FIG. 12, in block B1305 in FIG. 13, and in block B1405 in FIG. 14.

The data-grouping unit 1722 groups data into one or more MM groups according to one or more grouping criteria, which may be included in grouping policies; removes data with low intra-group, inter-modality correlations from groups; and generates groups (e.g., high-correlation groups) that include multiple intermediate-data groups or that include at least one intermediate-group with at least one SM group. For example, some embodiments of the data-grouping unit 1722 perform at least some of the operations that are described in block B210 in FIG. 2; in blocks B310 and B320 in FIG. 3; in blocks B420, B432, and B450 in FIG. 4; and in blocks B1, B3, and B6 in FIG. 8.

The model-selection unit 1723 selects one or more machine-learning models or one or more late-fusion models based on one or more criteria and adds late-fusion flags to data based on one or more criteria. For example, some embodiments of the model-selection unit 1723 perform at least some of the operations that are described in blocks B220-B225 in FIG. 2; in blocks B330-B335 in FIG. 3; in blocks B410-B417, B432, B447, and B455-B470 in FIG. 4; in blocks B1202 and B1204 in FIG. 12; in blocks B1310 and B1320 in FIG. 13; in blocks B1410, B1425, B1445, and B1450 in FIG. 14; and in blocks B1522, B1524, and B1526 in FIG. 15.

The model-execution unit 1724 inputs data into one or more ML models or into one or more late-fusion models, executes the ML models or the late-fusion models, obtains the outputs of the ML models or the late-fusion models, and stores the outputs of the ML models or the late-fusion models in the data, classification results, and features repository 129. For example, some embodiments of the model-execution unit 1724 perform at least some of the operations that are described in blocks B215 and B225-B235 in FIG. 2; in blocks B315, B325, B335, B340, and B345 in FIG. 3; in blocks B412, B437, B455, B465, and B470 in FIG. 4; in blocks B4, B7, B8, and B9 in FIG. 8; in blocks B1203 and B1205 in FIG. 12; in blocks B1315 and B1325 in FIG. 13; in blocks B1420, B1430, B1435, and B1455 in FIG. 14; and in blocks B1520 and B1530 in FIG. 15.

The calculation unit 1725 calculates intra-group, inter-modality correlations between data in groups and calculates inter-group correlations between data in different groups (intermediate-data groups and single-modality groups). For example, some embodiments of the calculation unit 1725 perform at least some of the operations that are described in block B320 in FIG. 3, in blocks B425 and B440 in FIG. 4, and in blocks B2 and B5 in FIG. 8.

The configuration unit 1726 receives classification settings (e.g., grouping criteria, classification objectives) from an input device.

The display-control unit 1731 controls a display device to display classification results (e.g., second classification results), for example by displaying a graphical-user interface on the display device.

In the description, specific details are set forth in order to provide a thorough understanding of the embodiments disclosed. However, well-known methods, procedures, components and circuits may not have been described in detail in order to avoid unnecessarily lengthening the present disclosure.

Also, if a member (e.g., element, part, component) is referred herein as being “on,” “against,” “connected to,” or “coupled to” another member, then the member can be directly on, against, connected or coupled to the other member, but intervening members may also be present between the member and the other member. In contrast, if a member is referred to as being “directly on,” “directly against,” “directly connected to,” or “directly coupled to” another member, then there are no intervening members present between the member and the other member.

Furthermore, the terms “comprising,” “having,” “includes,” “including,” and “containing” are to be construed as open-ended terms unless otherwise noted. Accordingly, these terms, when used in the present specification, specify the presence of described features, integers, steps, operations, elements, materials, or members, but do not preclude the presence or addition of one or more other features, integers, steps, operations, elements, materials, or members that are not explicitly described.

While certain embodiments have been described, these embodiments have been presented by way of example only and are not intended to limit the scope of every embodiment. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

1. A method comprising:
obtaining data in multiple modalities, including data in an image modality and data in a biomarker modality;
obtaining one or more trained machine-learning models;
generating a first multi-modality group from the data in multiple modalities, wherein the first multi-modality group includes at least one of data in the image modality and data in the biomarker modality;
generating a group of intermediate data, wherein generating the group of intermediate data includes inputting the first multi-modality group into a first machine-learning model that has been trained to extract features from input multi-modality data and output the features as the intermediate data; and
generating a first classification result based on at least the group of intermediate data, wherein generating the first classification result includes inputting at least the group of intermediate data into a second machine-learning model that has been trained to output the classification result based on at least the group of intermediate data.

2. The method of claim 1, wherein the data in the image modality include data that define one or more of the following: an x-ray image, a computed-tomography image, a magnetic-resonance-imaging image, a fluoroscopic image, an ultrasound image, and a positron-emission-tomography image.

3. The method of claim 1, wherein generating the first multi-modality group includes grouping the data in multiple modalities into the first multi-modality group and one or more other groups, based on the data in multiple modalities and on one or more grouping criteria.

4. The method of claim 3, wherein the grouping criteria are related to at least one of data formats and correlations between data.

5. The method of claim 1, wherein the data in multiple modalities further include data in a text modality.

6. The method of claim 1, wherein generating the first classification result further includes inputting a group of single-modality data into the second machine-learning model with the group of intermediate data, and
wherein the second machine-learning model has been trained to output the classification result further based on the group of single-modality data.

7. The method of claim 1, further comprising:
generating a second classification result based on a group of single-modality data from the data in multiple modalities, wherein generating the second classification result includes inputting the group of single-modality data into a third machine-learning model that has been trained to output the classification result based on the group of single-modality data.

8. The method of claim 7, further comprising:
generating a third classification result based on the first classification result and the second classification result.

9. The method of claim 8, wherein the third classification result indicates one or more of the following: whether a tumor is benign or malignant; whether a tumor is an invasive cancer or a non-invasive caner; and whether a cancer is a Luminal type, Her2-enriched type, or Triple Negative Breast Cancer subtype.

10. A device comprising:
one or more processors; and
one or more memories, wherein the one or more processors and the one or more memories are configured to:
obtain data in multiple modalities, including data in an image modality and data in a biomarker modality;
obtain one or more trained machine-learning models;
generate a first multi-modality group from the data in multiple modalities, wherein the first multi-modality group includes at least one of data in the image modality and data in the biomarker modality;
generate a group of intermediate data, wherein generating the group of intermediate data includes inputting the first multi-modality group into a first machine-learning model that has been trained to extract features from input multi-modality data and output the features as the intermediate data; and
generate a first classification result based on at least the group of intermediate data, wherein generating the first classification result includes inputting at least the group of intermediate data into a second machine-learning model that has been trained to output the classification result based on at least the group of intermediate data.

11. One or more computer-readable media storing instructions that, when executed by one or more computing devices, cause the one or more computing devices to perform operations comprising:
obtaining data in multiple modalities, including data in an image modality and data in a biomarker modality;
obtaining one or more trained machine-learning models;
generating a first multi-modality group from the data in multiple modalities, wherein the first multi-modality group includes at least one of data in the image modality and data in the biomarker modality;
generating a group of intermediate data, wherein generating the group of intermediate data includes inputting the first multi-modality group into a first machine-learning model that has been trained to extract features from input multi-modality data and output the features as the intermediate data; and
generating a first classification result based on at least the group of intermediate data, wherein generating the first classification result includes inputting at least the group of intermediate data into a second machine-learning model that has been trained to output the classification result based on at least the group of intermediate data.

12. A method comprising:
obtaining data in a first modality and data in a second modality;
obtaining one or more trained machine-learning models;
generating groups of multi-modality data from the data in the first modality and the data in the second modality, wherein each of the groups of multi-modality data includes some of the data in the first modality and some of the data in the second modality;
inputting each of the groups of multi-modality data into one of a first plurality of machine-learning models, wherein each machine-learning model of the first plurality of machine-learning models outputs a respective group of intermediate data that the machine-learning model generated based on the input group of multi-modality data;
inputting the groups of intermediate data into a second plurality of machine-learning models, wherein each machine-learning model of the second plurality of machine-learning models outputs a respective classification result that the machine-learning model generated based on the input group of intermediate data.

13. A method comprising:
obtaining data in multiple modalities;
obtaining one or more grouping criteria;
obtaining one or more trained machine-learning models;
generating groups of multi-modality data from the data in multiple modalities according to the one or more grouping criteria, wherein each of the groups of multi-modality data includes data in at least two modalities; and
performing intermediate fusion on one or more groups of multi-modality data using one or more of the trained machine-learning models, which generates one or more first classification results.

14. The method of claim 13, further comprising:
performing early fusion on at least one group of single-modality data from the data in multiple modalities one or more of the trained machine-learning models, which generates one or more first classification results.

15. The method of claim 14, further comprising:
performing late fusion on the first classification results using one or more late-fusion models, which generates a second classification result.

16. The method of claim 15, wherein late fusion is performed using a majority-voting model, a weighted-average model, or a stacking model.

17. A device comprising:
one or more processors; and
one or more memories, wherein the one or more processors and the one or more memories are configured to:
obtain data in multiple modalities;
obtain one or more grouping criteria;
obtain one or more trained machine-learning models;
generate groups of multi-modality data from the data in multiple modalities according to the one or more grouping criteria, wherein each of the groups of multi-modality data includes data in at least two modalities; and
perform intermediate fusion on one or more groups of multi-modality data using one or more of the trained machine-learning models, which generates one or more first classification results.

18. One or more computer-readable media storing instructions that, when executed by one or more computing devices, cause the one or more computing devices to perform operations comprising:
obtaining data in multiple modalities;
obtaining one or more grouping criteria;
obtaining one or more trained machine-learning models;
generating groups of multi-modality data from the data in multiple modalities according to the one or more grouping criteria, wherein each of the groups of multi-modality data includes data in at least two modalities; and
performing intermediate fusion on one or more groups of multi-modality data using one or more of the trained machine-learning models, which generates one or more first classification results.
